(19) United States
(12) Patent Application Publication
(10) Pub. No.: US 2026/0120009 A1
(43) Pub. Date: Apr. 30, 2026

(54) SYSTEM AND METHOD FOR GENERATING AND PROPAGATING PRO-ACTIVE ACTION PAYLOADS TO REMEDIATE, SECURE, AND MANAGE A PLURALITY OF INFORMATION HANDLING SYSTEMS WITHIN AN ENTERPRISE

(71) Applicant: Dell Products LP, Round Rock, TX (US)

(72) Inventors: Balasingh Ponraj Samuel, Round Rock, TX (US); Daniel L. Hamlin, Round Rock, TX (US); Srikanth Kondapi, Austin, TX (US)

(73) Assignee: Dell Products LP, Round Rock, TX (US)

(21) Appl. No.: 18/929,466

(22) Filed: Oct. 28, 2024

(51) Int. Cl. G06Q 10/0631

(52) U.S. Cl. CPC G06Q 10/0631

(57) ABSTRACT

An information handling system includes a hardware processor to execute computer-readable program code instructions of an information technology decision maker (ITDM) capability management system to receive assigned artificial intelligence (AI) productivity scores correlated to how executed capability intent actions at a subset of a plurality of node information handling systems in an enterprise have improved user productivity at those plurality of node information handling systems based on detected changes resource telemetry data. The ITDM capability management system to generate a ranked listing of the plurality of responsive capability intent actions based on the assigned AI productivity scores and determine an action payload comprising one or more highest AI productivity score responsive capability intent actions and propagate that action payload to each of the plurality of node information handling systems within the enterprise for implementation.

### FIELD OF THE DISCLOSURE

The present disclosure generally relates to execution of computer-readable program code instructions for one or more artificial intelligence (AI) productivity tools at one or more node information handling systems generating responsive actions to user-query inputs. The present disclosure more specifically relates systems and methods of generating pro-active action payloads from use of an AI productivity tool at a node information handling system with an information technology decision maker (ITDM) capability management system at a remote management server to secure, remediate, or manage AI productivity tool usage at a plurality of node information handling systems.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions of one or more workspace productivity applications or other application such as for teleconferencing, word processing, sales systems, business software, gaming applications, or the like. Additionally, node information handling systems may be managed by an enterprise information technology (IT) management service at a remote server information handling system. Further, the information handling system may include an on the box (OTB) artificial intelligence (AI) productivity tool employing machine learning (ML) models stored locally at the information handling system, as installed by a manufacturer of the information handling system, for optimizing user productivity and information handling system performance.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system for executing computer-readable program code instructions of an artificial intelligence (AI) productivity tool software module to identify and select responsive software services, hardware operations, or other capabilities of a plurality of AI productivity tool-enablable software applications and an internet technology decision maker (ITDM) capability management system to generate pro-active action payloads for the information handling systems according to an embodiment of the present disclosure;

FIG. 2 is a graphic and block diagram illustrating a node information handling system among a plurality of node information handling systems that includes computer-readable program code instructions of AI productivity tool software modules to identify and select responsive capabilities of a plurality of AI productivity tool-enablable software applications and an ITDM capability management system to generate pro-active action payloads for the information handling systems according to an embodiment of the present disclosure;

FIG. 3 is a flow diagram showing a method of executing computer-readable program code instructions of an ITDM capability management system for creating proactive action payloads for implementation at a plurality of node information handling systems within an enterprise according to an embodiment of the present disclosure according to an embodiment of the present disclosure; and

FIG. 4 is a flow diagram showing a method of executing computer-readable program code instructions of an ITDM capability management system for creating proactive action payloads for implementation at a plurality of node information handling systems within an enterprise according to an embodiment of the present disclosure according to another embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Information handling systems, including computers, mobile computers, and smart phones are increasingly employing execution of computer readable code instructions of artificial intelligence (AI) productivity tools to optimize user productivity and performance of the information handling systems. Examples of such artificial intelligence methodologies includes chatbots to simulate conversations between the information handling system and the user. In an example embodiment of the present disclosure, an AI productivity tool may be executed to trigger changes in firmware or hardware (e.g., changing display or power settings), software, or processes of one or more other AI productivity tool-enablable software applications (e.g., send an e-mail or text message, schedule a meeting). Various machine learning models may be used by the AI productivity tool to support such functionality, including automatic speech recognition (ASR) models, text embedding models, and similarity search models that may work in combination with one another to identify a responsive capability intent action that may be taken by an AI productivity tool enablable software application as requested within a received user-query input according to embodiments herein. For example, an existing AI productivity tool may be capable of determining a user's intent in a query intent value from a user-query input for correlation to a capability intent action having a capability intent value via lexical or semantic similarity matching of that determined query intent value with a capability intent value. Such capabilities of AI productivity tool-enablable software applications are accessible based on published or established capabilities by a particular of one or more AI productivity tool-enablable software applications executing at the information handling system stored in system capabilities database. In some embodiments, once the AI productivity tool-enablable software application capable of performing the responsive capability to the user-query input is identified, the AI productivity tools may identify an application programming interface (API) call that, when executed, may cause the AI productivity tool-enablable software application associated with the identified responsive capability to perform that responsive capability intent action.

However, execution of computer readable code instructions of such an AI productivity tool may only be as productive as a user that properly uses the AI productivity tool. For example, some users may not ask relevant questions or otherwise provide relevant user-query inputs to the AI productivity tool in an attempt to make changes in firmware or hardware (e.g., changing audio settings at one or more speakers), software, or processes at the information handling system. In other embodiments, the Users with limited technical knowledge may not be able to take full advantage of the available capabilities of AI productivity tool-enablable software applications via the AI productivity tool described in the present specification. This limits the amount of productivity that otherwise may have been realized if the user was relatively more technically knowledgeable regarding how to interact with the AI productivity tool.

Indeed, in some instances, an internet technology decision maker (ITDM) or other manager of a plurality of information handling systems within an enterprise may wish to have those capabilities invoked for changes in firmware or hardware, software, or processes at the information handling system made by relatively more technical knowledgeable users of an AI productivity tool to be leveraged on behalf of other users in the enterprise. Where, for example, a technologically knowledgeable user of an AI productivity tool at a node information handling system has made capability intent action changes in firmware or hardware, software, or processes at the information handling system using the available capabilities of AI productivity tool-enablable software applications that increase productivity of the user, the ITDM may be interested in having those same or similar capability changes in firmware, hardware, or software made available and applied to those node information handling systems with deployed AI productivity tools operated by relatively lower technologically-advanced users.

Some minority portion of users of managed node information handling systems may actively use an AI productivity tool thereon to enhance system functions on their node information handling systems. An enterprise may prefer to assist the other portions of managed node information handling systems to utilized useful features, configurations, and functions available via the AI productivity tool deployed across these managed node information handling systems. The present specification describes systems and methods of creating proactive action payloads for implementation at a plurality of node information handling systems managed by a remote policy management server executing an ITDM capability management system within an enterprise in an embodiment. In an example embodiment, an ITDM may operate the remote policy management server for creating proactive action payloads for implementation at a plurality of node information handling systems within an enterprise based off of successful AI productivity tool usage at one of the node information handling systems. This server may include a hardware processor, a memory device, and a power management unit to provide power to the hardware processor and memory device. The hardware processor may execute computer-readable program code instructions of an ITDM capability management system to receive data describing how a plurality of responsive capability intent actions that are responsive to user-query input from users of one or more node information handling systems within an enterprise has improved user productivity at those one or more node information handling systems. Further, the ITDM capability management system may receive assigned or generated AI productivity scores related to how the executed capability intent actions have improved user productivity at the plurality of information handling systems. In an embodiment, the hardware processor may execute computer-readable program code instructions of the ITDM capability management system to generate a ranked listing of the plurality of responsive capability intent actions based on the assigned or determined AI productivity scores. Still further, execution of the computer-readable program code instructions of the ITDM capability management system may generate an action payload comprising one or more of the plurality of responsive capability intent actions and associated user query inputs used to invoke those responsive capability intent actions having threshold or high AI productivity scores. As a result, execution of the computer-readable program code instructions of the ITDM capability management system to propagate that action payload to each of the plurality of node information handling systems managed within the enterprise for implementation at each of those plurality of node information handling systems.

In an embodiment, the hardware processor may execute the computer-readable program code instructions of the ITDM capability management system at a remote policy management server of an enterprise to access an enterprise capabilities and scoring database to store the responsive capability intent actions, associated user query inputs used to invoke those capability intent actions, and determined AI productivity scores of the responsive capability intent actions. Determined AI productivity scores of the responsive capability intent actions are assessed at each node information handling system via code instructions of a productivity and experience score monitor that determines applicability of the responsive capability intent action to conditions at the node information handling system. For example, if a high intensity workload is detected at a node information handling system, then a responsive capability intent action to adjust settings to an ultraperformance mode, as opposed to a quiet mode, may correlated at a percentage correlation as responsive that may serve as an AI productivity score reported back to the remote policy management server along with the capability intent action executed and user query input used. These AI productivity scores may be used for reference when generating the ranked listing of the plurality of responsive capability intent actions based on the assigned AI productivity scores for action payloads to be transmitted to particular node information handling systems.

Additionally, in an embodiment, the hardware processor may execute the computer-readable program code instructions of the ITDM capability management system to receive an identification associated with the received responsive capability intent actions and associated user query inputs used to invoke that responsive capability intent action for comparison to identifications of the responsive capability intent actions stored on an enterprise capabilities and scoring database accessible to the ITDM capability management system including those AI productivity scores in embodiments herein. In an embodiment, the hardware processor may execute the computer-readable program code instructions of the ITDM capability management system to generate the ranked listing of the plurality of responsive capability intent actions by averaging an accumulated assigned AI productivity score associated with each type of responsive capability intent action and generating the ranked listing based on the average accumulated assigned AI productivity score. For example, application of a responsive capability intent action to transition to ultraperformance mode may not always occur when a high intensity workload is detected and thus, in some reported AI productivity scores for certain node information handling systems, the responsive capability intent action with a particular identification may not be as high and therefore not universally applicable.

In some embodiments, the hardware processor may execute the computer-readable program code instructions of the ITDM capability management system to disregard responsive capability intent actions that cannot result in improved user productivity at the plurality of node information handling systems. In this embodiment, the enterprise capabilities and scoring database is updated to comprise a listing of responsive capability intent actions that do not result in improved user productivity at the plurality of node information handling systems for reference by the ITDM capability management system.

In other embodiments, the hardware processor may execute the computer-readable program code instructions of an ITDM capability management system to group the plurality of node information handling systems within the enterprise into categories of node information handling systems that includes non-benefitting node information handling systems that would not benefit from the receipt of an action payload for a particular detected capability intent action and user query input pair as well as benefitting node information handling systems that would benefit from the receipt of the action payload. In an example embodiment, a group of node information handling systems within the enterprise may be categorized as an engineering team and may require access to a capability intent action for transition to ultraperformance since processing workload intensities may be high for software applications and systems such as engineering design or compiler applications executing on the engineering team category subset of node information handling systems. In another example embodiment, a group of node information handling systems within the enterprise may be categorized as a sales team and may require access to a capability intent action for transition to adjustment to networked communication bandwidths since usage of communication bandwidths may be high for software applications and systems for videoconferencing applications or presentation applications executing on the sales team category subset of node information handling systems. This allows further customization of individual groups of node information handling systems within the enterprise to benefit from implementations of only those triggered capability intent action changes in firmware, hardware, software, or other processes of one or more other AI productivity tool-enablable software applications based on available hardware, firmware, software at those node information handling systems or current telemetry of activity or intended roles of usage of those node information handling systems. Current telemetry of activity or intended roles of usage of those node information handling systems may include current loads of processing or communication, or currently or expected software systems to be executed, among other factors of operation for such categorized node information handling systems relative to a particular responsive capability intent action for an action payload.

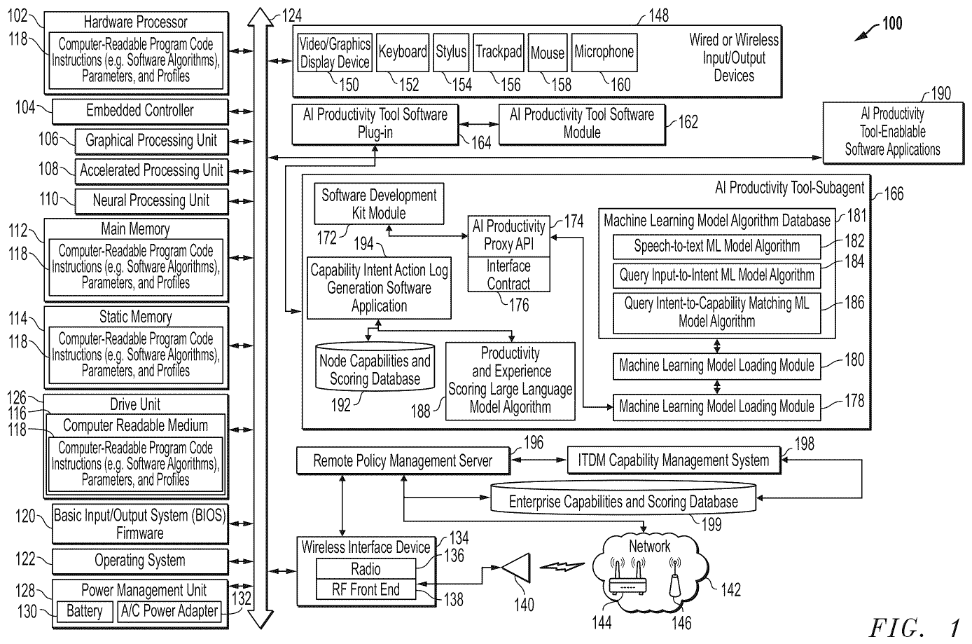

Turning now to the figures, FIG. 1 illustrates an information handling system 100 similar to the information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 144, a base station transceiver 146, a wireless telephone, a control system, a camera, a scanner, a printer, a personal trusted device, a web appliance, or any other suitable machine capable of executing a set of instructions (sequential or otherwise) that specify capability intent actions to be taken by that machine, and may vary in size, shape, performance, price, and functionality.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 112, (volatile (e.g., random-access memory, etc.), or static memory 114, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, a neural processing unit (NPU) 110, an accelerated processing unit (APU) 108, other types of hardware processing devices, or any combination thereof. It is appreciated that the information handling system 100 may include any number of hardware processing devices described herein. Computer readable code instructions stored in main memory 112 (e.g., RAM) may be quickly accessible by hardware processing resources using that main memory 112. Computer-readable program code instructions stored in static memory 114, main memory 112, or drive unit 126 may be longer term storage and some latency may be involved in invoking such computer-readable program code instructions to main memory 112 according to embodiments herein. Additional components of the information handling system 100 may include one or more storage devices such as static memory 114 or drive unit 126. The information handling system 100 may include or interface with one or more communications ports for communicating with external devices, as well as various input and output (I/O) devices 148, such as a mouse 158, a trackpad 156, a stylus 154, a keyboard 152, a video/graphics display device 150, a microphone 160, or any combination thereof. Portions of an information handling system 100 may themselves be considered information handling systems 100.

Information handling system 100 may include devices or modules that embody one or more of the devices or execute instructions for one or more systems and modules. The information handling system 100 may execute computer-readable program code instructions (e.g., software algorithms) parameters, and profiles 118 that may operate on servers or systems, remote data centers, or on-box in individual client information handling systems according to various embodiments herein. In some embodiments, it is understood any or all portions of computer-readable program code instructions (e.g., software algorithms) parameters, and profiles 118 may operate on a plurality of information handling systems 100.

The information handling system 100 may include the hardware processor 102 such as a central processing unit (CPU) or other hardware processing resources. Any of the hardware processing resources may operate to execute code that is either firmware or software code. Moreover, the information handling system 100 may include memory such as main memory 112, static memory 114, and disk drive unit 126 (volatile (e.g., random-access memory, etc.), nonvolatile memory (read-only memory, flash memory etc.) or any combination thereof or other memory with computer readable medium 116 computer-readable program code instructions (e.g., software algorithms) parameters, and profiles 118 executable by the hardware processor 102 (e.g., central processing unit), NPU 110, APU 108, EC 104, GPU 106, or any other hardware processing device. The information handling system 100 may also include one or more buses 124 operable to transmit communications between the various hardware components such as any combination of various I/O devices 148 as well as between hardware processors 102, an EC 104, the operating system (OS) 122, the basic input/output system (BIOS) 120, the network interface device 134 as a wired or wireless network interface device, or a radio module 136 and radiofrequency (RF) front end device 138, among other components described herein. In an embodiment, the hardware processor 102, EC 104, GPU 106, NPU 110, APU 108, and/or other hardware processing devices may execute one or more bus drivers in order to transmit this data between the information handling system 100 and the input/output devices 148 described herein. In an embodiment, the information handling system 100 may be in wired or wireless communication with the I/O devices 148 such as a keyboard 152, a mouse 158, video/graphics display device 150, stylus 154, trackpad 156, microphone 160, among other peripheral devices.

As described herein, the information handling system 100 further includes a video/graphics display device 150. The video/graphics display device 150 in an embodiment may function as a liquid crystal display (LCD), an organic light emitting diode (OLED), a flat panel display, or a solid-state display. It is appreciated that the video/graphics display device 150 may be wired or wireless and may be an external video/graphics display device 150 that allows a user to increase the desktop area by extending the desktop in an embodiment. Additionally, as described herein, the information handling system 100 may include or be operatively coupled to a cursor control device (e.g., a trackpad 156, or gesture or touch screen input), a stylus 154, and/or a keyboard 152, among others that allows the user to interface with the information handling system 100 via the video/graphics display device 150. Information handling system 100 may also be operatively coupled to a wired or wireless input/output device 148 or other hardware devices that may include a hardware processing device such as a hardware processor, microcontroller, or other hardware processing resource. Various drivers and hardware control device electronics may be operatively coupled to operate the I/O devices 148 according to the embodiments described herein. The present specification contemplates that the I/O devices 148 may be wired or wireless.

A network interface device of the information handling system 100 may be wired or wireless such as shown with network interface device 134 that can provide wireless connectivity among devices such as with Bluetooth® or to a network 142, e.g., a wide area network (WAN), a local area network (LAN), wireless local area network (WLAN), a wireless personal area network (WPAN), a wireless wide area network (WWAN), or other network. In embodiments described herein, the network interface device 134 may be a wireless interface adapter with its radio 136, RF front end 138 and antenna 140 is used to communicate with the wireless peripheral devices, via, for example, a Bluetooth® or Bluetooth® Low Energy (BLE) protocols or any proprietary RF protocol such as those may utilize similar frequency ranges but proprietary modulation and data transmission characteristics. In embodiments, Bluetooth®, BLE, proprietary RF protocol, or other WPAN or WLAN protocols and plural such protocols may be used for communication with and among any wireless peripheral device to be paired or paired with the information handling system 100 or other information handling systems.

In other embodiments, a WAN, WWAN, LAN, and WLAN may each include an AP 144 or base station 146 used to operatively couple the information handling system 100 to a network 142 via a wired or wireless network interface device 134. In a specific embodiment, the network 142 may include macro-cellular connections via one or more base stations 146 or a wireless AP 144 (e.g., Wi-Fi), or such as through licensed or unlicensed WWAN small cell base stations 146. Connectivity may be via wired or wireless connection. For example, wireless network wireless APs 144 or base stations 146 may be operatively connected to the information handling system 100. Network interface device 134 may include one or more RF (RF) subsystems (e.g., radio 136) with transmitter/receiver circuitry, modem circuitry, one or more antenna RF (RF) front end circuits 138, one or more wireless controller circuits, amplifiers, antennas 140 and other circuitry of the radio 136 such as one or more antenna ports used for wireless communications via multiple radio access technologies (RATs). The radio 136 may communicate with one or more wireless technology protocols.

In an embodiment, the network interface device 134 may operate in accordance with any wireless data communication standards. To communicate with a wireless local area network, standards including IEEE 802.11 WLAN standards (e.g., IEEE 802.11ax-2021 (Wi-Fi 6E, 6 GHZ)), IEEE 802.15 WPAN standards, WWAN such as 3GPP or 3GPP2, Bluetooth® standards, proprietary RF protocol, or similar wireless standards may be used. Network interface device 134 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The network interface device 134 or network interface device can represent an add-in card, wireless network interface module that is integrated with a main board of the information handling system 100 or integrated with another wireless network interface capability, or any combination thereof. In some embodiments, the network interface device 134 may also have wired capability of a wired network interface device.

In some embodiments, a hardware processing resource executes computer-readable program code instructions of software or firmware to implement one or more of some systems and methods described herein, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware devices with related control and data signals that may be communicated between and through the modules, or as portions of an application-specific integrated circuit. Accordingly, the present system encompasses a hardware processing resource executing computer-readable program code instructions of software or firmware as well as hardware implementations or any combination.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable program code instructions (e.g., software algorithms) parameters, and profiles 118 or receives and executes computer-readable program code instructions (e.g., software algorithms) parameters, and profiles 118 responsive to a propagated signal, so that a hardware device connected to a network 142 may communicate voice, video, or data over the network 142. Further, the computer-readable program code instructions, parameters, and profiles 118 may be transmitted or received over the network 142 via the network interface device 134.

The information handling system 100 may include a set of computer-readable program code instructions (e.g., software algorithms) parameters, and profiles 118 that may be executed to cause the computer system to perform any one or more of the methods or computer-based functions disclosed herein. For example, computer-readable program code instructions (e.g., software algorithms) parameters, and profiles 118 may be executed by a hardware processor 102, GPU 106, EC 104, APU 108, NPU 110, or any other hardware processing resource and may include software agents, or other aspects or components used to execute the methods and systems described herein. Various software modules comprising application computer-readable program code instructions (e.g., software algorithms) parameters, and profiles 118 may be coordinated by an OS 122, and/or via an application programming interface (API). An example OS 122 may include Windows®, Android®, and other OS types. Example APIs may include Win 32, Core Java API, or Android APIs.

In an embodiment, the information handling system 100 may include a disk drive unit 126. The disk drive unit 126 and may include computer-readable program code instructions (e.g., software algorithms) parameters, and profiles 118 in which one or more sets of computer-readable program code instructions (e.g., software algorithms) parameters, and profiles 118 such as firmware or software can be embedded to be executed by the hardware processor 102 (e.g., central processing unit (CPU)) or other hardware processing devices such as a graphics processing unit (GPU) 106, an embedded controller (EC) 104, a neural processing unit (NPU) 110, an accelerated processing unit (APU) 108, or other hardware processing resource device to perform the processes described herein. Similarly, main memory 112 and static memory 114 may also contain a computer-readable medium (e.g., 116) for storage of one or more sets of computer-readable program code instructions (e.g., software algorithms) parameters, and profiles 118 described herein. The disk drive unit 126 or static memory 114 also contain space for data storage. Further, the computer-readable program code instructions (e.g., software algorithms) parameters, and profiles 118 may embody one or more of the methods described herein. In a particular embodiment, the computer-readable program code instructions (e.g., software algorithms) parameters, and profiles 118 may reside completely, or at least partially, within the main memory 112, the static memory 114, and/or within the disk drive 126 during execution by the hardware processor 102, EC 104, APU 108, NPU 110, or GPU 106 of information handling system 100.

Main memory 112 or other memory of the embodiments described herein may contain computer-readable medium (not shown), such as RAM in an example embodiment. An example of main memory 112 includes random access memory (RAM) such as static RAM (SRAM), dynamic RAM (DRAM), non-volatile RAM (NV-RAM), or the like, read only memory (ROM), another type of memory, or a combination thereof. Static memory 114 may contain computer-readable medium (not shown), such as NOR or NAND flash memory in some example embodiments. The applications and associated APIs, for example, may be stored in static memory 114 or on the disk drive unit 126 that may include access to a computer-readable program code instructions (e.g., software algorithms) parameters, and profiles 118 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 128 (a.k.a. a power supply unit (PSU)). The PMU 128 may include a hardware controller and executable machine-readable code instructions to manage the power provided to the components of the information handling system 100 such as the hardware processor 102 and other hardware components described herein. The PMU 128 may control power to one or more components including the one or more drive units 126, the hardware processor 102 (e.g., CPU), the EC 104, the GPU 106, APU 108, NPU 110, a video/graphic display device 150, or other wired I/O devices 148 such as the mouse 158, the stylus 154, the keyboard 152, and the trackpad 156 and other components that may require power when a power button has been actuated by a user. In an embodiment, the PMU 128 may monitor power levels and be electrically coupled to the information handling system 100 to provide this power. The PMU 128 may be coupled to the bus 124 to provide or receive data or machine-readable code instructions. The PMU 128 may regulate power from a power source such as the battery 130 or AC power adapter 132. In an embodiment, the battery 130 may be charged via the AC power adapter 132 and provide power to the components of the information handling system 100, via wired connections as applicable, or when AC power from the AC power adapter 132 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 116 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described in embodiments herein, the information handling system 100 includes an AI productivity tool software module 162 and an AI productivity tool subagent 166 to select among a plurality of machine learning (ML) model algorithms 182, 184, 186 for use with execution of a plurality of AI productivity tool-enablable software applications 190 according to another embodiment of the present disclosure. In example embodiments, AI productivity tool-enablable software applications 190 may include a remediation (AMDS) software application, Dell® Optimizer® software application, Dell® Trusted Device® software application, Dell® Display and Peripheral Manager® software application, Alienware® Command Center (AWCC) software application, Dell® Support Assist® software application, virtual assistant module. As described herein, the AI productivity tool software module 162 and AI productivity tool subagent 166 may be executed by a hardware processor 102 on the information handling system 100 thereby allowing the methods described herein to be carried out on-the-box such that a wired or wireless network connection to a network is not necessary for operation of the method. In another embodiment, some modules, databases, and/or processing resources may be maintained on a remote server, for example a remote policy management server 196 or other remote server, such that a wired or wireless network connection can be made with these remote servers and the method may be implemented as described herein.

The AI productivity tool software module 162 may include any artificial intelligence-based productivity tool to assist in interfacing with and execution of one or more AI productivity tool-enablable software applications 190 or inputs (e.g., user-query input) and responses from a user of an information handling system 100. The AI productivity tool software module 162 may be loaded on-the-box by a manufacturer in software and may include chatbot features, virtual assistant features, and other artificial intelligence features that allow a user to provide input to the information handling system 100 and, with generative artificial intelligence processing of a user input query, execute one or more capabilities that include hardware operations, functions, software services, or responses using one or more AI productivity tool-enablable software applications 190. Examples of some AI productivity tool software module 162 may include Cortana® by Microsoft®, Copilot® by Microsoft®, Siri® by Apple® Inc., Gemini® by Google AIR, ChatGPT® by OpenAI®, and Amazon Alexa® by Amazon®, among others. It is appreciated that the information handling system 100 may include any proprietary AI productivity tool software module 162 installed by an information handling system 100 manufacturer and used to interface with the information handling system 100 and the operations thereon. In various embodiments, the hardware processor 102 or other alternative hardware processing resources of the information handling system 100 may execute computer-readable program code instructions of the AI productivity tool software module 162 with its AI productivity tool plug-in 164 and monitor for user input for a user query at a microphone 160, keyboard 152, trackpad 156, or other input device for the AI productivity tool software module 162 to engage in capability intent actions pursuant to the user-query input.

The AI productivity tool software module 162, executing on the hardware processor 102 or other hardware processing resource (e.g., EC 104, GPU 106, APU 108, or NPU 110), may interface with other hardware components and with the AI productivity tool-enablable software applications 190 and one or more ML module algorithms 182, 184, 186 on a ML model algorithm database 181 and with the information handling system 100 via an AI productivity tool plug-in 164. The AI productivity tool plug-in 164 may be any software or firmware that allows the AI productivity tool software module 162 to perform those actions at the information handling system 100 based on user-query input (e.g., typed, spoken words, images, etc.) provided from the user. The AI productivity tool plug-in 164 may be used by the AI productivity tool software module 162 and AI productivity tool subagent 166 to interface with any number of AI productivity tool-enablable software applications 190 executing or executable on the information handling system 100 according to embodiments herein.

The information handling system 100 also includes the AI productivity tool subagent 166 of the AI productivity tool software module 162. The AI productivity tool subagent 166 may be any software and/or firmware executable by the hardware processor 102 of the information handling system 100 to interface one or more of the plurality of the AI productivity tool-enablable software applications 190 to provide AI enabled capabilities within those AI productivity tool-enablable software applications 190 for responsive hardware, firmware, or software operations, functions, software services, or responses to user input queries. In an embodiment, the computer-readable program code instructions of the software applications (e.g., AI productivity tool-enablable software applications 190) and modules described herein may operate wholly “on-box” within the information handling system 100 or be subagents on-box for interfacing with remote software systems executing at remote server locations such as the remote policy management server 196 described herein. In an embodiment, the AI productivity tool subagent 166 may be used to direct the execution of various modules in support of the AI productivity tool-enablable software applications 190 described herein. Additionally, the AI productivity tool subagent 166 may be provided with access to the BIOS and OS of the information handling system 100 to conduct the capability intent actions pursuant to the user's query input provided via the AI productivity tool software module 162 or with an interface of one of the AI productivity tool-enablable software applications 190.

In an embodiment, the hardware processor 102 or other hardware processing resource (e.g., EC 104, GPU 106, CPU, APU 108, or NPU 110) executing computer-readable program code instructions of the AI productivity tool subagent 166 causes the AI productivity tool subagent 166 to engage with a machine learning model requesting module 178 to have one or more ML module algorithms 182, 184, 186 loaded and executed on the hardware processor in order to, initially, determine the query intent value to be correlated with a capability intent action that will be conducted in response to a received user-query input at the AI productivity tool software module 162 as described. In an embodiment, the execution of the computer-readable program code instructions of the AI productivity tool subagent 166 may call a software development kit (SDK) module 172. The SDK module 172 may include any computer-readable program code instructions that is executed by the hardware processor 102 or other hardware processing resource to request that any type or combination of types of ML module algorithms 182, 184, 186 be invoked to support an identification of, in an embodiment, a capability intent action that would appropriately address the received user-query inputs from a user. For example, the machine learning model loading module 180, pursuant to an interface contract 176 generated by the AI productivity proxy API 174, may load a speech-to-text model algorithm 182 in order to, where necessary, convert any audio user-query input into text or other machine-readable program code instructions for further processing by the AI productivity tool subagent 166. In an embodiment, the speech-to-text model algorithm 182 may include an automatic speech recognition ML model algorithm or other speech recognition ML model algorithm. A further example of a ML model algorithm 182, 184, 186 includes a query input-to-intent ML model algorithm 184 that may receive the converted user-query input from the speech-to-text model algorithm 182 or directly from the AI productivity tool subagent 166, and with an embedding algorithm generate a vectorized query intent value for the user query input for later correlation with a capability intent value. Additionally, the query intent-to-capability matching ML model algorithm 186 receives that vectorized query intent value as input and matches the vectorized query intent value to a vectorized capability intent value associated with the AI productivity tool-enablable software application 190 via a similarity correlation algorithm to identify a capability from, for example, a system capabilities database (not shown) that can serve as the capability intent action responsive to a user query input. It is appreciated that this process of identifying a capability responsive to the user-query input may include the identification of a plurality of capabilities that can be executed to perform a plurality of capability intent actions. Thus, a plurality of AI productivity tool-enablable software applications 190 may be directed to carry out each of these plurality of capability intent actions based on identified capabilities that correlate to those capabilities associated with these plurality of AI productivity tool-enablable software applications 190.

During operation, it may be beneficial to track how the execution of these identified capabilities result in capability intent actions that increase productivity at the information handling system 100. For example, a user may request to “make my system run faster” in order to increase hardware processing resources so that, for example, a processing intensive software application (e.g., a computer-aided design (CAD) drawing software application) can run more smoothly. This may be a result of the user detecting this processing intensive software application is not immediately responsive to input provided by the user. As such, this user-query input (e.g., make my system run faster”) may cause the AI productivity tool subagent 166 to invoke one or more of the ML model algorithms 182, 184, 186 in order to identify a capability associated with an AI productivity tool-enablable software application 190 that can address this lag in processing input at the processing intensive software application. Having completed this capability intent action, data including the user query input, the capability or capability intent action, and resulting telemetry data change (e.g., hardware processor consumption levels or lag levels) where applicable may be gathered at a capability intent action log generation software application 194 for use in the systems and method described herein. Execution of the computer-readable program code instructions (e.g., software algorithms) parameters, and profiles 118 of the capability intent action log generation software application 194 by a hardware processor (e.g., 102, 104, 106, 108, 110) the gathers of the capability intent action, user query input, and telemetry for hardware or software performance or system status before and after execution of the capability intent action carried out by any AI productivity tool-enablable software application 190 for a capability.

Execution of computer-readable program code instructions for the capability intent action log generation software application 194 may evaluate the capability intent action executed in view of the pre-telemetry and post-telemetry performance or status data to determine if it corresponds to an increase in productivity at the information handling system 100 that is represented by an AI productivity score that is a correlation between the capability intent action and the telemetry change in performance or status of hardware, software, or firmware systems on the node information handling system. In order to complete this AI productivity score evaluation, the capability intent action log generation software application 194 may execute computer-readable program code instructions (e.g., software algorithms) parameters, and profiles 118 of a productivity and experience scoring large language model (LLM) algorithm 188. The execution of the productivity and experience scoring LLM algorithm 188 causes various inputs to be received and a AI productivity scoring process to be conducted for an AI productivity score representing how each of a plurality of responsive capability intent actions that respond to user-query inputs at the node information handling system 100 improves or correlates to improvement of user productivity, such as addressing the a change in telemetry data for performance metrics or status of hardware, firmware or software at this node information handling system 100. Such an AI productivity score may be applied to an identification of the responsive capability intent action and user query input, as well as relevant telemetry data, for potential application across a plurality of node information handling systems in an enterprise in embodiments herein.

For example, the inputs to the productivity and experience scoring LLM algorithm 188 may include, but may not be limited to, pre and post capability intent action telemetry data metrics related to performance or status of the hardware of the information handling system 100, the software of the information handling system 100 (e.g., the OS), power states and maximum clock frequencies of selected components of the information handling system 100, peripheral devices coupled to the information handling system 100 (either permanently or temporarily), networks available to the information handling system 100 and the performance characteristics of those networks, software installers available on the information handling system 100 and the like. For example, these pre and post capability intent action telemetry data metrics may include clock frequencies of a hardware processor that have been increased by execution of, for example, Dell® Optimizer® software application in order to increase processing capacity of the information handling system 100 in order to address the user-query input (e.g., “make my system run faster”). Other executed capabilities and pre and post capability intent action telemetry data metrics used as input to the productivity and experience scoring LLM algorithm 188 may include the amount of RAM currently occupied and/or cleared by execution of the Dell® Optimizer® software application. Still further, other capabilities and pre and post capability intent action telemetry data metrics that may be used as input to the productivity and experience scoring LLM algorithm 188 may include current temperatures at the battery 130 and hardware processing devices (102, 104, 106, 108, 110) that may have increased as a result of increasing the processing resources at the information handling system 100. Yet another capability and pre and post capability intent action telemetry data metric data that may be used as input to the productivity and experience scoring LLM algorithm 188 may include data describing which, if any, background applications have been stopped in order to cause hardware processing resources. It is appreciated that any pre and post capability intent action telemetry data metrics associated with the changes in firmware or hardware (e.g., changing display or power settings), software, or processes of one or more other AI productivity tool-enablable software applications resulting from the execution of a capability intent action may be used as input to the productivity and experience scoring LLM algorithm 188.

The execution of the productivity and experience scoring LLM algorithm 188 by the capability intent action log generation software application 194 may further generate and assign the AI productivity score related to how the executed capability intent actions have improved user productivity at the plurality of information handling systems. Again, this AI productivity score is based on the current metrics detected and gathered before and after execution of the responsive capability intent action by the capability intent action log generation software application 194 and provided as input to the productivity and experience scoring LLM algorithm 188. A statistical correlation is made between the executed capability intent action and changes in performance or status of hardware, software, or firmware telemetry data that indicate whether increased productivity has occurred at the information handling system 100 relating to effectiveness of the responsive capability intent action generating the change in performance or status of hardware, software, or firmware telemetry data that is an improvement for the user and the user's expected functions on that node information handling system. In some embodiments, the associated user query input is also input into the productivity and experience scoring LLM algorithm 188 for correlation to a particular performance or status of hardware, software, or firmware telemetry data that was inquired about in the user query input.

In an embodiment, to calculate the productivity score, the productivity and experience scoring LLM algorithm 188 receives, as input, two or more of a resource telemetry data metric associated with hardware of the client device, a resource telemetry data metric associated with software or firmware of the client device, a resource telemetry data metric associated with a storage system, a resource telemetry data metric associated with a user of the client device, a resource telemetry data metric associated with a network of the client device, or a resource telemetry data metric associated with a locale of the client device. A statistical correlation is drawn between the capability for the capability intent action and changes in the resource telemetry data metrics associated with the capability and even the original user query input by the productivity and experience scoring LLM algorithm 188 and this statistical correlation, for example out of a normalized correlation value may represent the output AI productivity score. For example, an output AI productivity score may be on a scale of between 1 to 10 such that a 10 indicates that user-productivity has been increased in that the capability intent action and user query input pair more directly correlated to changes in the resource telemetry data metrics. In this example embodiment, a score of 1 indicates that the associated capability intent action and user query input pair has little to no effect on changes in the resource telemetry data metrics and, thus, little effect on the user productivity at the information handling system 100.

In an embodiment, the developed AI productivity scores for identified capability intent action and user query input pairs may be stored on a node capabilities and scoring database 192. This node capabilities and scoring database 192 may be routinely accessed by the capability intent action log generation software application 194 in order for the capability intent action log generation software application 194 to generate a capability intent action log. Execution of computer readable code instructions of the capability intent action log generation software application 194 at a node information handling system 100 enables an ITDM at an enterprise to conduct ongoing monitoring of user query inputs and capability intent action responses of the AI productivity tool 162 for reporting and use at the remote policy management server 196. This capability intent action log may, in an embodiment, associate each executed capability intent action, its associated capability, the associated AI productivity tool-enablable software application 190 that executed that capability, an associated user query input, a capability identification, and the assigned AI productivity score previously generated by the execution of the productivity and experience scoring LLM algorithm 188. Further, pre and post capability intent action changes in the relevant resource telemetry data metrics associated with the capability and user query input may also be recorded in the capability intent action log in some embodiments.

In an embodiment, this capability intent action log may be reported to an ITDM capability management system 198 executing at a remote policy management server 196 and collected or aggregated in an enterprise capabilities and scoring data base 199 from a plurality of node information handling systems. In this way, execution of code instructions for the ITDM capability management system 198 may rank each of the executed capability intent actions collected from across one or more node information handling systems based on their AI productivity score. The ITDM capability management system 198 may then determine a list of top user-productive capability intent actions that have most significantly increased the productivity by the user at the one or more monitored node information handling systems 100 based upon their respective AI productivity scores.

The hardware processor 102 executing computer readable code instructions of the capability intent action log generation software application 194 may periodically send the generated capability intent action log to the ITDM capability management system 198. In other embodiments, the capability intent action log generation software application 194 may send the capability intent action log to the ITDM as new capability intent actions have been carried out and the capability intent action log has been updated. The ITDM capability management system 198 execute a remote policy management server 196 via the network 142 described herein. In an embodiment, the information handling system 100 may be operatively coupled to the network 142 and the remote policy management server 196 and ITDM capability management system 198 via a wired or wireless connection as described herein.

During operation, the ITDM may make decisions regarding if and how similar capability intent actions executed at any of the monitored node information handling systems 100 within an enterprise are to be applied to other information handling systems within the enterprise. In such an embodiment, execution of computer readable code instructions at the remote policy management server 196 of the ITDM capability management system 198 may determine which capability intent actions received should be included as part of action payload for distribution to other node information handling systems 100. Thus, in an embodiment, the node information handling system 100 shown in FIG. 1 may be one of a plurality of node information handling systems within an enterprise with each of these node information handling systems being referred to as node information handling systems relative to the remote policy management server 196 and ITDM capability management system 198. The ITDM may be responsible for managing the operation of each of these node information handling systems 100 and providing for an action payload for distribution to each of these node information handling systems 100 describing which, if any, capability intent actions should be carried out at one or more of the node information handling systems 100 that would also increase user productivity as indicated and determined from the capability intent action logs with AI productivity scores for those capability intent actions sent from other monitored node information handling system 100 in the enterprise as described herein.

In an embodiment, a hardware processor of the remote policy management server 196 may execute computer-readable program code instructions of the ITDM capability management system 198 to receive the data describing how a plurality of responsive capability intent actions, responsive to user-query input from the plurality of users of the plurality of node information handling systems within the enterprise has improved user productivity at those plurality of node information handling systems. Again, this data is presented as the capability intent action logs sent from the node information handling systems 100 to the remote policy management server 196 and ITDM capability management system 198. In an embodiment, the execution of the computer-readable program code instructions (e.g., software algorithms) parameters, and profiles of the ITDM capability management system 198 also causes the ITDM capability management system 198 to receive data describing the assigned AI productivity scores related to how the executed capability intent actions have improved user productivity at the plurality of information handling systems 100 via correlation to changes in pre and post capability intent action telemetry data metric data.

In an embodiment, the execution of the computer-readable program code instructions of the ITDM capability management system 198 generates a ranked listing of the plurality of responsive capability intent actions based on the assigned AI productivity scores received in capability intent action logs. This ranked listing may rank the capability intent actions received from the capability intent action logs by averaging an accumulated assigned AI productivity score associated with each type of responsive capability intent action from a plurality of monitored node information handling systems. The correlation of the capability intent action to the pre and post capability intent action telemetry data metric data, and thus the assigned AI productivity scores, may differ among various node information handling systems 100. Thus, in an embodiment, execution of the computer readable code instructions of the ITDM capability management system 198 generates the ranked listing based on averaging accumulated assigned AI productivity scores for each type of capability intent action. In another embodiment, execution of the computer readable code instructions of the ITDM capability management system 198 generates the ranked listing based on averaging accumulated assigned AI productivity scores for each type of capability intent action and user query input pair. In yet another embodiment, each of the AI productivity scores associated with each similar type of capability intent action as detailed in the plurality of received capability intent action logs from each node information handling system 100 may be added together and normalized to fit within a scale of 1 to 10 with 1 being the least user-productive capability intent action and a score of 10 being the most user-productive capability intent action.

In an embodiment, this ranked listing created by the ITDM capability management system 198 may be used to generate an action payload comprising one or more of the plurality of responsive capability intent actions. These responsive capability intent actions defined in the action payload may be used to improve the user-productivity at each node information handling system 100 that the action payload is transmitted to. Thus, in an embodiment, the hardware processor 102 may execute computer-readable program code instructions of the ITDM capability management system 198 to propagate that action payload to each of the plurality of node information handling systems 100 within the enterprise for implementation at each of those plurality of node information handling systems. Execution of the computer-readable program code instructions of the ITDM capability management system 198 to propagate that action payload to each of the plurality of node information handling systems 100 within the enterprise may transmit those action payloads via a certification process in embodiments herein For example, an action payload certification process may include use of a symmetric encryption key with a public key on the node information handling system 100 and a private key at the remote policy management server 196 in some embodiments. Similar certification process may be used during transmission of intent action logs between a monitored node information handling system 100 and the remote policy management server 196 in other embodiments herein.

It is appreciated that, in some instances, the propagation of some of the action payload may not be beneficial to all of the node information handling systems 100 within the enterprise. For example, the overclocking of a hardware processor (e.g., the executed capability intent action) may have been beneficial to a user of the information handling system 100 who has requested to “make my system run faster” in order to address the input issues associated with the execution of a CAD drawing software application. This user may be part of an engineering product development department within the enterprise and would benefit from the execution of the capability intent action. However, a similar capability intent action may not be beneficial for a node information handling system 100 within another department of the enterprise such as a sales department node information handling system 100 or a lawyer's node information handling system 100. In an embodiment, the computer-readable program code instructions (e.g., software algorithms) parameters, and profiles 118 of the ITDM capability management system 198 may allow the ITDM to define a grouping of node information handling systems 100 within the enterprise such that specific and customized action payloads may be propagated to a subgroup of node information handling systems 100 within the enterprise that would benefit from the action payload. Thus, the ITDM capability management system 198 may allow the ITDM to define for the same action payload to not be sent to another sub-group of node information handling systems 100 within the enterprise in other embodiments that would not benefit from the application of the capabilities defined in the action payload.

In an embodiment, the ITDM may be provided with a user interface such as a mouse and a video-graphics display device at the remote policy management server 196 such that the ITDM may define these sub-groups within the enterprise of node information handling systems 100. In this way, some determined action payloads may be applicable across all node information handling systems 100, while other action payloads may be determined applicable over any of one or more subgroups of node information handling systems 100. For example, the ITDM may define a plurality of sub-groups such as engineers, sales people, C-suite employees, inventors, human resources, accounting, legal, or the like. It is appreciated that the ITDM may direct that some of these node information handling systems 100 within the sub-groups may receive the action payloads while others will not because their assigned sub-group would not benefit from those action payloads. Further, determination of AI productivity scores from reported capability intent action logs may be particularized to node information handling systems 100 in a particular subgroup for determination of appropriate action payloads for that subgroup. For example, the ITDM may indicate that those action payloads generated from capability intent action logs from node information handling systems 100 in the engineering sub-group of the enterprise are not to be propagated to those node information handling systems 100 associated with those node information handling systems 100 within a sale department sub-group. This is done, again, because the operation of the node information handling systems 100 by the users within these two different sub-groups are not similar and would not be beneficial to those users within the other sub-group. Thus, in some situations, the ITDM capability management system 198 may disregard responsive capability intent actions carried out on some node information handling systems 100 that cannot result in improved user productivity at other node information handling systems 100. In an embodiment, a listing of non-beneficial capability intent actions may be maintained on, for example, an enterprise capabilities and scoring database 199 that have been determined to not increase user productivity at some or all of the node information handling systems 100.

In an embodiment, the hardware processor of the remote policy management server 196 may further execute the computer-readable program code instructions of the ITDM capability management system 198 to access an enterprise capabilities and scoring database 199. The enterprise capabilities and scoring database 199 may be used to store the responsive capability intent actions and assigned AI productivity scores of the responsive capability intent actions in reported capability intent action logs from each node information handling system 100 for reference by the ITDM capability management system 198 when generating the ranked listing of the plurality of responsive capability intent actions based on the assigned AI productivity scores. Again, the ranked listing of the plurality of responsive capability intent actions are presented in the action payload propagated by the ITDM capability management system 198 to one or more of the node information handling systems 100 as described herein. Additionally, the enterprise capabilities and scoring database 199 may be used by the ITDM capability management system 198 to compare the identification of each capability intent action defined in the capability intent action log from each node information handling system 100 to an identification of the responsive capability intent actions stored on the enterprise capabilities and scoring database. This allows the ITDM capability management system 198 to match up those capability intent actions carried out at each node information handling system 100 in order to create the ranked listing of capability intent actions within the action payload.

The action payload may then be transmitted to one or more of the node information handling systems 100, similar to the information handling system 100 shown in FIG. 1 for execution at their respective AI productivity tool subagents 166. Because the action payload transmitted from the ITDM capability management system 198 and remote policy management server 196 to these node information handling systems 100 includes those highest ranked capability intent actions that increases the user productivity of the information handling system 100, other node information handling systems 100 may benefit from those capabilities intent actions executed at a single information handling system 100 thereby increasing user productivity within the enterprise generally. This creates a system and method that creates pro-active action payloads to remediate, secure, and manage the node information handling systems in an enterprise that may not effectively be using the AI productivity tool thereby allowing for shared generated user productivity solutions.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

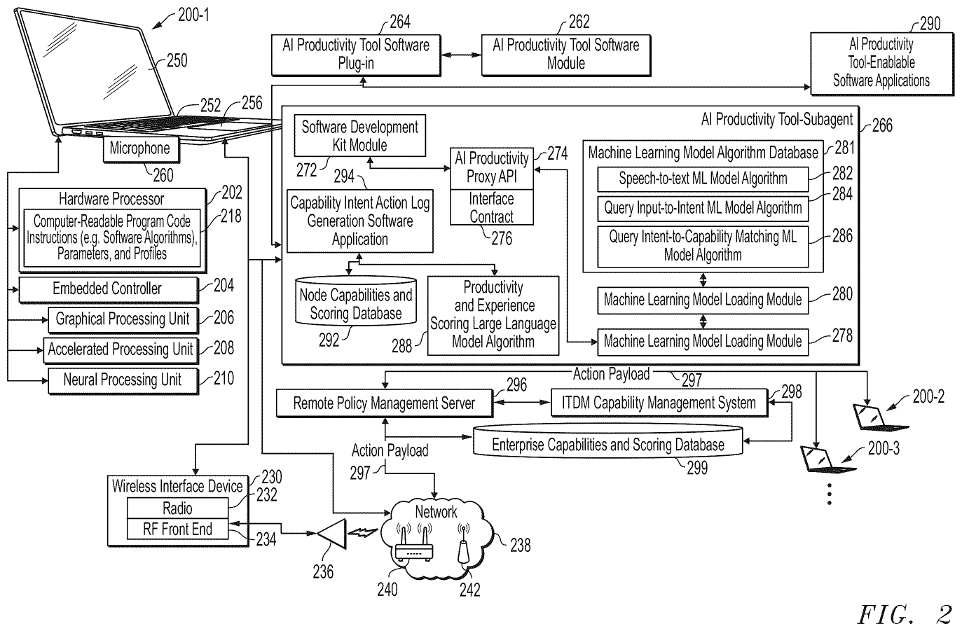

FIG. 2 is a graphic and block diagram illustrating a plurality of node information handling systems such that a node information handling system includes computer-readable program code instructions of an ITDM capability management system to generate pro-active action payloads for the node information handling systems executing an AI productivity tool software module according to an embodiment of the present disclosure. The node information handling systems 200-1, 200-2, 200-3 execute the AI productivity tool software module 262 to identify and select responsive software services, operations, or other available capabilities of a plurality of AI productivity tool-enablable software applications 290 executing in those information handling systems 200-1, 200-2, 200-3. As described herein, a node information handling system 200-1 may be one of many monitored node information handling systems 200-1, 200-2, 200-3 within an enterprise. The node information handling systems 200-1, 200-2, 200-3 shown in FIG. 2 may form, at least, part of an enterprise within, for example, a company or other organization. As described herein, each of these node information handling systems 200-1, 200-2, 200-3 may be operatively coupled, either via a wire or wirelessly, to a remote policy management server 289 executing an ITDM capability management system 287 on behalf of the ITDM.

The node information handling systems 200-1, 200-2, 200-3 are shown as laptop-type node information handling systems 200-1, 200-2, 200-3 in FIG. 2. It is appreciated that other types of information handling systems may form part of the enterprise, and the present specification contemplates these other types of information handling systems as described herein. In the embodiment shown in FIG. 2, the node information handling systems 200-1, 200-2, 200-3 may each include a video/graphics display device 250, a keyboard 252, and a trackpad 256 as well as other input/output devices that allow each user of the node information handling systems 200-1, 200-2, 200-3 to receive output and provide input at the node information handling systems 200-1, 200-2, 200-3. For purposes of explanation, a first information handling system 200-1 may be representative of the other second and third information handling systems 200-2, 200-3 shown in FIG. 2 such that the second and third information handling systems 200-2, 200-3 may comprise similar computer-readable program code instructions, parameters, profiles, modules, software applications, and hardware as that described in connection with the first information handling systems 200-1.

As described in embodiments herein, the information handling systems 200-1, 200-2, 200-3 may each include an AI productivity tool software module 262 and an AI productivity tool subagent 266 to select among a plurality of machine learning (ML) model algorithms 282, 284, 286 for use with execution of a plurality of AI productivity tool-enablable software applications 290 described herein according to another embodiment of the present disclosure. As described herein, the AI productivity tool software module 262 and AI productivity tool subagent 266 may be executed by a hardware processor 202 on the information handling systems 200-1, 200-2, 200-3 thereby allowing the methods described herein to be carried out on-the-box such that a wired or wireless network connection to a network is not necessary for operation of the method. In another embodiment, some modules, databases, and/or processing resources may be maintained on a remote server such that a wired or wireless network connection can be made with these remote servers and the method may be implemented as described herein.

The AI productivity tool software module 262 may include any artificial intelligence-based productivity tool to assist in interfacing with and execution of one or more AI productivity tool-enablable software applications 290 or inputs (e.g., user-query input) and responses from a user of an information handling systems 200-1, 200-2, 200-3. The AI productivity tool software module 262 may be loaded on-the-box by a manufacturer in software and may include chatbot features, virtual assistant features, and other artificial intelligence features that allow a user to provide input to the information handling systems 200-1, 200-2, 200-3 and, with generative artificial intelligence processing of a user input query, execute one or more capabilities that include hardware operations, functions, software services, or responses using one or more AI productivity tool-enablable software applications 290. It is appreciated that the information handling systems 200-1, 200-2, 200-3 may include any proprietary AI productivity tool software module 262 installed by an information handling systems 200-1, 200-2, 200-3 manufacturer and used to interface with the information handling systems 200-1, 200-2, 200-3 and the operations thereon. In various embodiments, the hardware processor 202 or other alternative hardware processing resources of the information handling systems 200-1, 200-2, 200-3 may execute computer-readable program code instructions of the AI productivity tool software module 262 with its AI productivity tool plug-in 264 and monitor for user input for a user query at a microphone 260, keyboard 252, trackpad 256, or other input device for the AI productivity tool software module 262 to engage in capability intent actions pursuant to the user-query input.

The AI productivity tool software module 262, executing on the hardware processor 202 or other hardware processing resource (e.g., EC 204, GPU 206, APU 208, or NPU 210), may interface with other hardware components and with the AI productivity tool-enablable software applications 290 and one or more ML module algorithms 282, 284, 286 on a ML model algorithm database 281 and with the information handling systems 200-1, 200-2, 200-3 via an AI productivity tool plug-in 264. The AI productivity tool plug-in 264 may be any software or firmware that allows the AI productivity tool software module 262 to perform those actions at the information handling systems 200-1, 200-2, 200-3 based on user-query input (e.g., typed, spoken words, images, etc.) provided from the user. The AI productivity tool plug-in 264 may be used by the AI productivity tool software module 262 and AI productivity tool subagent 266 to interface with any number of AI productivity tool-enablable software applications 290 executing or executable on the information handling systems 200-1, 200-2, 200-3 according to embodiments herein.

The information handling systems 200-1, 200-2, 200-3 also include the AI productivity tool subagent 266 of the AI productivity tool software module 262. The AI productivity tool subagent 266 may be any software and/or firmware executable by the hardware processor 202 of the information handling systems 200-1, 200-2, 200-3 to interface one or more of the plurality of the AI productivity tool-enablable software applications 290 to provide AI enabled capabilities within those AI productivity tool-enablable software applications 290 for responsive hardware, firmware, or software operations, functions, software services, or responses to user input queries. In an embodiment, the computer-readable program code instructions of the software applications (e.g., AI productivity tool-enablable software applications 290) and modules described herein may operate wholly “on-box” within the information handling systems 200-1, 200-2, 200-3 or be subagents on-box for interfacing with remote software systems executing at remote server locations such as the remote policy management server 296 described herein. In an embodiment, the AI productivity tool subagent 266 may be used to direct the execution of various modules in support of the AI productivity tool-enablable software applications 290 described herein. Additionally, the AI productivity tool subagent 266 may be provided with access to the BIOS and OS of the respective information handling systems 200-1, 200-2, 200-3 to conduct the capability intent actions pursuant to the user's query input provided via the AI productivity tool software module 262 or with an interface of one of the AI productivity tool-enablable software applications 290.

In an embodiment, the hardware processor 202 or other hardware processing resource (e.g., EC 204, GPU 206, CPU, APU 208, or NPU 210) executing computer-readable program code instructions of the AI productivity tool subagent 266 causes the AI productivity tool subagent 266 to engage with a machine learning model requesting module 278 to have one or more ML module algorithms 282, 284, 286 loaded and executed on the hardware processor in order to, initially, determine the query intent value to be correlated with a capability intent action that will be conducted in response to a received user-query input at the AI productivity tool software module 262 as described. In an embodiment, the execution of the computer-readable program code instructions of the AI productivity tool subagent 266 may call an SDK module 272. The SDK module 272 may include any computer-readable program code instructions that is executed by the hardware processor 202 or other hardware processing resource to request that any type or combination of types of ML module algorithms 282, 284, 286 be invoked to support an identification of, in an embodiment, a capability intent action that would appropriately address the received user-query inputs from a user. For example, the machine learning model loading module 280, pursuant to an interface contract 276 generated by the AI productivity proxy API 274, may load a speech-to-text model algorithm 282 in order to, where necessary, convert any audio user-query input into text or other machine-readable program code instructions for further processing by the AI productivity tool subagent 266. In an embodiment, the speech-to-text model algorithm 282 may include an automatic speech recognition ML model algorithm or other speech recognition ML model algorithm. A further example of a ML model algorithm 282, 284, 286 includes a query input-to-intent ML model algorithm 284 that may receive the converted user-query input from the speech-to-text model algorithm 282 or directly from the AI productivity tool subagent 266, and with an embedding algorithm generate a vectorized query intent value for the user query input for later correlation with a capability intent value. Additionally, the query intent-to-capability matching ML model algorithm 286 receives that vectorized query intent value as input and matches the vectorized query intent value to a vectorized capability intent value associated with the AI productivity tool-enablable software application 290 via a similarity correlation algorithm to identify a capability from, for example, a system capabilities database (not shown) that can serve as the capability intent action responsive to a user query input. It is appreciated that this process of identifying a capability responsive to the user-query input may include the identification of a plurality of capabilities that can be executed to perform a plurality of capability intent actions. Thus, a plurality of AI productivity tool-enablable software applications 290 may be directed to carry out each of these plurality of capability intent actions based on identified capabilities that correlate to those capabilities associated with these plurality of AI productivity tool-enablable software applications 290.

During operation, it may be beneficial to track how the execution of these identified capabilities results in capability intent actions that increase productivity at the information handling systems 200-1, 200-2, 200-3. For example, a user may request to “make my system run faster” in order to increase hardware processing resources so that, for example, a processing intensive software application (e.g., a computer-aided design (CAD) drawing software application) can run more smoothly. Additionally, the user may provide user-query input such as “make my screen brighter” in order to adjust the brightness of the video/graphics display device 250. It is appreciated that not all of these types of user-query inputs may or may not increase user productivity at the information handling system or, in other words, does not provide measurable metrics that show an increase in user productivity.

For example, the user-query input of “make my system run faster” may be made by the user when executing a processing intensive software application that is not immediately responsive to input provided by the user. As such, this user-query input (e.g., “make my system run faster”) may cause the AI productivity tool subagent 266 to invoke one or more of the ML model algorithms 282, 284, 286 in order to identify a capability associated with an AI productivity tool-enablable software application 290 that can address this lag in processing input at the processing intensive software application. Having completed this capability intent action, the responsive capability intent action, the user query input, and telemetry data for the status or performance of hardware, software, or firmware before and after execution of the capability intent action may be gathered at a capability intent action log generation software application 294 for use in the systems and method described herein.

Execution of the computer-readable program code instructions of the capability intent action log generation software application 294 by a hardware processor (e.g., 202, 204, 206, 208, 210) gathers data of the capability intent actions carried out by any AI productivity tool-enablable software application 290, the user query input and telemetry data for hardware, firmware, or software performance or system status before and after execution of the capability intent action carried out by any AI productivity tool-enablable software application 290 for a capability. This gathered data for an executed capability intent action is evaluated to determine an AI productivity score representing correlation of the capability intent action with a change in telemetry for hardware or software performance or system status before and after execution of the capability intent action that may be requested or an improvement and which may represent whether productivity at the information handling systems 200-1, 200-2, 200-3 has increased. In order to complete this AI productivity score evaluation, the capability intent action log generation software application 294 may execute computer-readable program code instructions of a productivity and experience scoring LLM algorithm 288. The execution of the productivity and experience scoring LLM algorithm 288 causes various inputs to be received and a scoring process to be conducted describing correlation of execution for responsive capability intent actions responsive to user-query inputs (e.g., of “make my system run faster” or “make my screen brighter”) of the information handling systems 200-1, 200-2, 200-3 with a change in telemetry for hardware or software performance or system status before and after execution of the capability intent action that may be requested or an improvement that has improved user productivity at a node information handling system (e.g., at 200-1).

For example, the inputs to the productivity and experience scoring LLM algorithm 288 may include, but may not be limited to hardware, software, or firmware performance or system status telemetry metrics before and after execution of the capability intent action an related to the operation, consumption, or status of hardware of the information handling systems 200-1, 200-2, 200-3, the software of the information handling systems 200-1, 200-2, 200-3 (e.g., the OS), power states and maximum clock frequencies of selected components of the information handling systems 200-1, 200-2, 200-3, peripheral devices coupled to the information handling systems 200-1, 200-2, 200-3 (either permanently or temporarily), networks available to the information handling systems 200-1, 200-2, 200-3 and the performance characteristics of those networks, software installers available on the information handling systems 200-1, 200-2, 200-3, and the like. For example, these performance or system status telemetry metrics may include clock frequencies of a hardware processor that have been increased by execution of, for example, Dell® Optimizer® software application in order to increase processing capacity of the information handling systems 200-1, 200-2, 200-3 in order to address the user-query input (e.g., “make my system run faster”).

In another example, these performance or system status telemetry metrics may include GPU temperature readings that indicate that the temperature of the GPU has increased due to, for example, a Dell® Display and Peripheral Manager® software application, executing a capability to increase the resolution and processing of graphics by the GPU for display on the display device. It is appreciated that other executed capabilities and performance or system status telemetry metrics may be used as input to the productivity and experience scoring LLM algorithm 288 that may include the amount of RAM currently occupied and/or cleared by execution of the Dell® Optimizer® software application, for example. Still further, other capabilities and performance or system status telemetry metrics that may be used as input to the productivity and experience scoring LLM algorithm 288 that may include current temperatures at the battery 230 or hardware processing devices (202, 204, 206, 208, 210) that may have increased as a result of increasing the processing resources at the information handling systems 200-1, 200-2, 200-3. Yet another capability and performance or system status telemetry metrics data that may be used as input to the productivity and experience scoring LLM algorithm 288 may include data describing which, if any, background applications are operating or have been stopped in order to cause hardware processing resources. It is appreciated that any performance or system status telemetry metrics associated with the before telemetry data and changes in firmware, hardware, software, or processes with one or more other AI productivity tool-enablable software applications resulting from the execution of a capability intent action may be used as input to the productivity and experience scoring LLM algorithm 288 in embodiments herein.

The execution of the productivity and experience scoring LLM algorithm 288 by the capability intent action log generation software application 294 may further generate and assign an AI productivity score related to how the executed capability intent actions statistically correlate to changes in the telemetry data and whether those changes in the detected telemetry data relate to improved user productivity for the tasks of a user or operation of the user's node information handling system 200-1, 200-2, or 200-3. Again, this AI productivity score is based on the prior and current performance or system status telemetry metrics to the execution of the capability intent action and detected and gathered by the capability intent action log generation software application 294. This performance or system status telemetry metrics is provided, along with the capability intent action and the user query input as input to the productivity and experience scoring LLM algorithm 288 to identify a statistical correlation, as an AI productivity score, between the executed capability intent action and the change in relevant performance or system status telemetry metrics associated with the increased productivity of the user at the node information handling system (e.g., 200-1, 200-2, 200-3). Further, relevant performance or system status telemetry metrics may be determined from input into the productivity and experience scoring LLM algorithm 288 the user query input and persona data for a user, such as expected work functions or software applications expected to be used by a user in some embodiments to determine relevance of changes in performance or system status telemetry metrics to that user or category of user productivity.

In an embodiment, to calculate the productivity score, the productivity and experience scoring LLM algorithm 288 receives, as input, two or more of a resource telemetry data metric associated with hardware of the client device, a resource telemetry data metric associated with software or firmware of the client device, a resource telemetry data metric associated with a storage system, a resource telemetry data metric associated with a user of the client device, a resource telemetry data metric associated with a network of the client device, or a resource telemetry data metric associated with a locale of the client device. A statistical correlation is drawn between the capability for the capability intent action and changes in the resource telemetry data metrics associated with the capability in an embodiment. Relevant resource telemetry data metrics may be determined based on the original user query input or persona information about expected user functions at a node information handling system 200-1 by the productivity and experience scoring LLM algorithm 288. The statistical correlation determined by the productivity and experience scoring LLM algorithm 288 between the executed capability intent action and the detected relevant resource telemetry data metrics may yield a normalized correlation value that may represent the output AI productivity score. For example, an output AI productivity score may be on a scale of between 1 to 10 such that a 10 indicates that user-productivity has been increased in that the capability intent action and user query input pair more directly correlated to changes in the resource telemetry data metrics that represent an improvement of function for a user. In this example embodiment, a score of 1 indicates that the associated capability intent action and user query input pair has little to no effect on changes in the resource telemetry data metrics and, thus, little effect on the user productivity at the information handling system 200-1, 200-2, 200-3.

In an embodiment, the developed AI productivity scores may be stored on a node capabilities and scoring database 292 in a capability intent action log. As an example of a capabilities intent action log, a table may be created with each of the identified capabilities, capability identifications, and their respective scores relating to the increase (or lack thereof) of user productivity resulting from the execution of the capabilities after a capability intent action has been conducted. Additional information may be included in the capability intent action log including the user query input and relevant resource telemetry data metrics in other embodiments. An example of this table is shown in Table 1 here:

| Capability | | |
|---|---|---|
| Identification | User Productivity Score | Capability |
| 0002 | 3 | Clear RAM |
| 0006 | 9 | Stop background applications |
| 0013 | 1 | Brighten display |
| 0004 | 10 | Overclock hardware |
| | | processor |
| 0015 | 2 | Reduce fan noise |
| 0021 | 1 | Disable camera in BIOS setup |

The node capabilities and scoring database 292 may be routinely accessed by the capability intent action log generation software application 294 in order for the capability intent action log generation software application 294 to generate and maintain such a capability intent action log. This capability intent action log may, in an embodiment, associate each executed capability intent action, its associated capability, the associated AI productivity tool-enablable software application 290 that executed that capability, a user query input, a capability identification, the relevant resource telemetry data metrics, and the assigned AI productivity score previously generated by the execution of the productivity and experience scoring LLM algorithm 288. In an embodiment, this capability intent action log may then be reported to an ITDM capability management system 298 at a remote policy management server 296. Upon reporting one or more capability intent action logs from one or more node information handling systems 200-1, 200-2, 200-3, the ITDM capability management system 298 may rank each of the executed capability intent actions from plural capability intent action logs based on their AI productivity score, or a averaged AI productivity score in embodiments herein. This may set up a highest AI productivity score list, for example a top ten list or a list of those capability intent actions exceeding an AI productivity score, for identifying the most user-productive capability intent actions that have most significantly increased the productivity for a user at one or more information handling systems 200-1, 200-2, 200-3 based upon those respective AI productivity scores.

The capability intent action log generation software application 294 may periodically send the generated capability intent action log to an ITDM operating an ITDM capability management system 298. In an embodiment, the capability intent action log generation software application 294 may send the capability intent action log to the ITDM as new capability intent actions have been carried out and the capability intent action log has been updated with new scores associated with new capabilities and their respective capability intent actions.

In an embodiment, the ITDM capability management system 298 may be accessible on a server such as a remote policy management server 296 via the connection to the network 240 described herein. In an embodiment, the information handling systems 200-1, 200-2, 200-3 may be operatively coupled to the network 242 along with the remote policy management server 296 and ITDM capability management system 298 via a wired or wireless connection as described herein. During operation, the ITDM may make decisions regarding if and how similar capability intent actions executed at the node information handling systems 200-1, 200-2, 200-3 within an enterprise are to be applied to others of the node information handling systems 200-1, 200-2, or 200-3 within the enterprise. Thus, in an embodiment, the node information handling systems 200-1, 200-2, 200-3 shown in FIG. 2 may be one a plurality of node information handling systems within an enterprise relative to the remote policy management server 296 and ITDM capability management system 298. The ITDM may be responsible for managing the operation of each of these node information handling systems 200 and providing an action payload for distribution to each of these node information handling systems 200 describing which, if any, capability intent actions should be carried out at one or more of the node information handling systems 200 that would also increase user productivity at those node information handling systems 200-1, 200-2, 200-3 as indicated by the capability intent action logs received according to embodiments described herein.

In an embodiment, a hardware processor of the remote policy management server 296 may execute computer-readable program code instructions of the ITDM capability management system 298 to receive the capability intent action logs with data describing how a plurality of responsive capability intent actions are executed and responsive to user-query inputs from the plurality of node information handling systems 200-1, 200-2, 200-3 within the enterprise as well as AI productivity scores indicating to what degree changes to relevant resource telemetry data has improved user productivity at the plurality of node information handling systems. Again, this data is presented as the capability intent action log sent from the information handling systems 200-1, 200-2, 200-3 to the remote policy management server 296 and ITDM capability management system 298. For example, Table 1 may be a capability intent action log in some embodiments. In an embodiment, the execution of the computer-readable program code instructions of the ITDM capability management system 298 causes the ITDM capability management system 298 to receive the capability intent action log data describing the assigned AI productivity scores related to how the executed capability intent actions have improved user productivity at the plurality of information handling systems 200-1, 200-1, and 200-3. Examples of these AI productivity scores are also reflected, for example, in Table 1 herein.

In an embodiment, the execution of the computer-readable program code instructions of the ITDM capability management system 298 generates a ranked listing of the plurality of responsive capability intent actions based on the assigned AI productivity scores, or in some embodiments, an average of the assigned AI productivity scores across similar capability intent actions executed on different node information handling systems 200-1, 200-2, or 200-3. This ranked listing may rank the capability intent actions received from the capability intent action logs by averaging an accumulated assigned AI productivity score associated with each type of responsive capability intent action and generating the ranked listing based on the average accumulated assigned AI productivity score. In an alternative embodiment, each of the scores associated with each similar capability intent action as detailed in the plurality of received capability intent action logs from each node information handling systems 200-1, 200-2, 200-3 may be added together and normalized to fit within a scale of 1 to 10 with 1 being the least user-productive capability intent action and a score of 10 being the most user-productive capability intent action.

In an embodiment, this ranked listing created by the ITDM capability management system 298 may be used to generate an action payload 297 comprising one or more of the plurality of responsive capability intent actions with a high AI productivity score that is above a threshold or makes a highest ranked list (e.g., a top five list). These responsive capability intent actions defined in the action payload 297 may be used to improve the user-productivity at each node information handling systems 200-1, 200-2, 200-3 that the action payload 297 is transmitted to. The selection of transmission of the action payload 297 by the ITDM capability management system 298 is based on the AI productivity scores for those capability intent actions being above a threshold AI productivity score or being ranked in a highest list of AI productivity scores for capability intent actions executed across the enterprise or across a category subset of node information handling systems (e.g., for the engineering department, the sales department, or other) according to embodiments herein. Thus, in an embodiment, the hardware processor may execute computer-readable program code instructions of the ITDM capability management system 298 to propagate that action payload 297 to each of the plurality of node information handling systems 200-1, 200-2, 200-3 within the enterprise, or a specified category subgroup, for implementation at each of those plurality of node information handling systems 200-1, 200-2, 200-3. For example, where the average AI productivity score related to a capability intent action that sets system to high performance mode/overclock hardware processor (e.g., capability ID 0004) is relatively higher across the enterprise than other capabilities that have increased user productivity at any given node information handling systems 200-1, 200-2, 200-3 (e.g., clear RAM; capability ID 0002), this capability may be selected for the action payload 297 as a capability for transmission to and execution at one or more others of the node information handling systems 200-1, 200-2, 200-3 in the enterprise.

It is appreciated that, in some instances, the propagation of some of the action payloads 297 may not be beneficial to all of the node information handling systems 200 within the enterprise. For example, the overclocking of a hardware processor (e.g., the executed capability intent action of 0004 in Table 1) may have been beneficial to a user of a first information handling system 200-1 who has requested to “make my system run faster” in order to address the input issues associated with the execution of a CAD drawing software application. That user may be part of an engineering subgroup within the enterprise with a user persona of functions performed in that engineering subgroup as operating processing intensive software applications such as the CAD drawing software application. Since this user and their node information handling system may be part of an engineering product development department within the enterprise, that node information handling system would benefit from the execution of the capability intent action for overclocking. However, a similar capability intent action may not be beneficial for a second or third information handling system 200-2, 200-3 within another department of the enterprise such as sales department information handling systems 200-2 or legal department information handling systems 200-3. In an embodiment, the computer-readable program code instructions of the ITDM capability management system 298 may allow the ITDM to define a grouping of node information handling systems 200-1, 200-2, 200-3 within the enterprise such that specific and customized action payloads 297 may be propagated to a subgroup of node information handling systems 200-1, 200-2, 200-3 within the enterprise based on relevance to user persona information and detected resource telemetry data for those subgroup node information handling systems that would benefit from the action payload 297 in embodiments. The computer-readable program code instructions of the ITDM capability management system 298 may allow the ITDM to define a grouping of node information handling systems 200-1, 200-2, 200-3 within the enterprise such that the same action payload 297 is not sent to another sub-group of node information handling systems 200-1, 200-2, 200-3 within the enterprise that would not benefit from the application of the capability intent actions defined in the action payload 297.

In an embodiment, the ITDM may be provided with a user interface such as a mouse and a video-graphics display device at the remote policy management server 296 such that the ITDM may define these sub-groups within the enterprise of node information handling systems 200-1, 200-2, 200-3. In this way, some determined action payloads 297 may be applicable across all node information handling systems 200-1, 200-2, 200-3, while other action payloads 297 may be determined applicable over any of one or more subgroups of node information handling systems 200-1, 200-2, 200-3. For example, the ITDM may define a plurality of sub-groups such as engineers, sales people, C-suite employees, inventors, human resources, accounting, legal, or the like. It is appreciated that the ITDM may direct that some of these node information handling systems 200-1, 200-2, 200-3 within the sub-groups may receive the action payloads 297 while others will not because their assigned sub-group would not benefit from those action payloads 297. Further, determination of AI productivity scores from reported capability intent action logs, such as Table 1, may be particularized to node information handling systems 200-1, 200-2, 200-3 in a particular subgroup for determination of appropriate action payloads 297 for that subgroup. For example, the ITDM capability management system 298 may determine and indicate that those action payloads 297 generated from capability intent action logs from node information handling systems 200-1, 200-2, 200-3 in the engineering sub-group of the enterprise are not to be propagated to those node information handling systems 200-1, 200-2, 200-3 associated with those node information handling systems 200-1, 200-2, 200-3 within a sale department sub-group. This is done, again, because the operation of the node information handling systems 200-1, 200-2, 200-3 by the users within these two different sub-groups are not similar and would not be beneficial to those users within the other sub-group. Thus, in some situations, the ITDM capability management system 298 may disregard responsive capability intent actions carried out on some node information handling systems 200-1, 200-2, 200-3 that cannot result in improved user productivity at other node information handling systems 200-1, 200-2, 200-3. In an embodiment, a listing of non-beneficial capability intent actions may be maintained on, for example, an enterprise capabilities and scoring database 299 that have been determined to not increase user productivity at some or all of the node information handling systems 200-1, 200-2, 200-3.

In an embodiment, the hardware processor of the remote policy management server 196 may further execute the computer-readable program code instructions of the ITDM capability management system 298 to access an enterprise capabilities and scoring database 299. The enterprise capabilities and scoring database 299 may be used to store the responsive capability intent actions and assigned AI productivity scores of the responsive capability intent actions in reported capability intent action logs from each node information handling system 200-1, 200-2, 200-3 for reference by the ITDM capability management system 298 when generating the ranked listing of the plurality of responsive capability intent actions based on the assigned AI productivity scores. Again, the ranked listing of the plurality of responsive capability intent actions may determine which responsive capability intent actions are presented in the action payload 297 propagated by the ITDM capability management system 298 to one or more of the node information handling systems 200-1, 200-2, 200-3 as described herein. Additionally, the enterprise capabilities and scoring database 299 may be used by the ITDM capability management system 298 to compare the identification of each capability intent action defined in the capability intent action log from each node information handling system 200-1, 200-2, 200-3 to identify common responsive capability intent actions stored on the enterprise capabilities and scoring database for purposes of averaging AI productivity scores. This allows the ITDM capability management system 298 to match up those capability intent actions carried out at each node information handling system 200-1, 200-2, 200-3 in order to create the ranked listing of capability intent actions within the action payload 297.

The action payload may then be transmitted to one or more of the node information handling systems 200-1, 200-2, 200-3 for execution at their respective AI productivity tool subagents 266. Because the action payload 297 transmitted from the ITDM capability management system 298 and remote policy management server 296 to these node information handling systems 200-1, 200-2, 200-3 includes those highest ranked capability intent actions that increase the user productivity of at least one or some of the information handling systems 200-1, 200-2, 200-3, other node information handling systems 200-1, 200-2, 200-3 in the enterprise may benefit from those capabilities intent actions thereby increasing user productivity within the enterprise generally. This creates a system and method that creates pro-active action payloads to remediate, secure, and manage the node information handling systems 200-1, 200-2, 200-3 in an enterprise that may not effectively be using the AI productivity tool 262 thereby allowing for shared generated user productivity solutions.

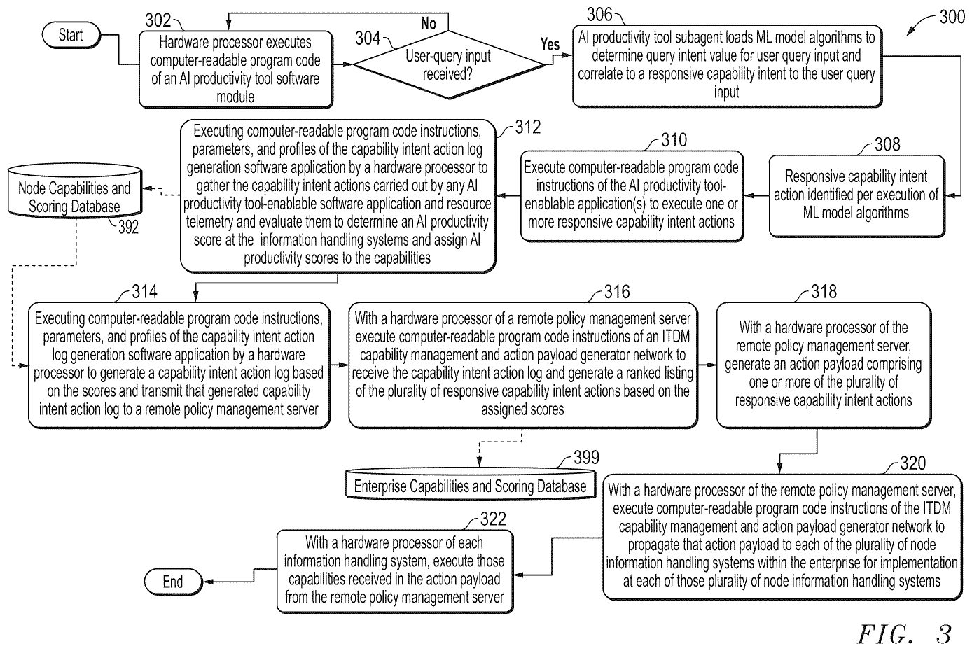

FIG. 3 is a flow diagram showing a method 300 of executing computer readable code instructions assessing AI productivity scores of capability intent actions for creating proactive action payloads for implementation at a plurality of information handling systems within an enterprise according to an embodiment of the present disclosure according to an embodiment of the present disclosure. The method 300 described in connection with FIG. 3 may be operated, at least partially, on an information handling system such as an information handling system (e.g., 100, 200-1, 200-2, 200-3) described in connection with FIG. 1 or 2 as well on a remote policy management server (e.g., 196, 296) described in connection with FIG. 1 or 2. In an embodiment, the information handling system may be one of a plurality of node information handling systems within an enterprise while the remote policy management server may be operatively coupled to each of the plurality of information handling systems using a wired or wireless connection. In an embodiment, an ITDM may be responsible for overseeing the generation of action payloads describing capability intent actions to a carried out and executed on one or more of these information handling systems within the enterprise to leverage operations of AI productivity tools on some of the node information handling systems to improve operation. This is done to create pro-active action payloads that remediate, secure, and manage the plurality of information handling systems within the enterprise thereby allowing for crowd generated user productivity solutions.

The method 300 may include, at block 302, the hardware processor or other hardware processing device of any of the information handling systems executes computer-readable program code instructions of the AI productivity tool software module to receive a user query input for access to one or more AI productivity tool software applications executing on the information handling system. In an embodiment, the AI productivity tool software module may be any application that can receive input from a user such as text input via the keyboard or speech input via the microphone. In some embodiments, text or audio may be received by an interface of the one or more AI productivity tool software applications and the interface managed by the AI productivity tool software module at block 302. In an embodiment, the AI productivity tool software module may include a virtual assistant-type AI software agent. In various embodiments, the hardware processor or other alternative hardware processing resources of the information handling system may execute computer-readable program code instructions of the AI productivity tool software application or AI productivity tool software module with its AI productivity tool software plug-in and monitor for user-query inputs at a microphone, keyboard, or other input device for the AI productivity tool subagent to engage in capability intent actions pursuant to the user-query inputs.

At block 304, the method 300 also includes determining whether any user-query input has been received at the AI productivity tool software module a node information handling systems. The processes of the AI productivity tool software module may operate on any of a plurality of node information handling systems in the enterprise. The AI productivity tool plug-in may monitor for input from an input/output device such as a trigger word or trigger keystroke for audio user-query inputs or activation of a graphical user interface to receive text user-query inputs. Where, at block 304, no user-query input is received, the method 300 returns to block 302 with the AI productivity tool software module continuing to monitor for this input. Where, at block 304, the AI productivity tool software module does detect and receive user-query input, the method 300 continues to block 306.

At block 306, the method 300 with the hardware processor executing an AI productivity tool subagent and its modules, algorithms, and software applications being executed by the hardware processor of the information handling system to identify a responsive capability of one or more AI productivity tool-enablable software applications executing at the node information handling system. In an embodiment, the AI productivity tool subagent may provide some or all of the AI productivity services as described herein. The AI productivity tool subagent includes execution of code instructions for an ML model requesting algorithm through an SDK module and an AI productivity proxy API to invoke one or more ML model algorithms to identify a responsive capability to the use query input.

For example, the machine learning model loading module, pursuant to the interface contract generated by the AI productivity proxy API, may load a speech-to-text model algorithm in order to, where necessary, convert any audio user-query input into text or other machine-readable program code instructions for further processing by the AI productivity tool subagent. Additional ML model algorithms may be requested for execution as well including a query input-to-intent ML model algorithm to execute a text embedding algorithm to generate query intent value for semantic meaning values assigned to the user-query input. Further, a query intent-to-capability ML model algorithm may also be requested for conducting any semantic or lexical similarity matching with capability intent values to determine a similarity matched responsive capability intent values for one or more capability intent actions to the user-query input in various embodiments herein. The AI productivity proxy API transmits this request for the ML model algorithms to the ML model requesting module. The ML model loading module loads the appropriate ML model algorithms pursuant to the request from the ML model requesting module.

In an embodiment, a speech-to-text model algorithm may be included among the plurality of available ML model algorithms. The speech-to-text model algorithm may, where necessary, convert any audio user-query input into text or other machine-readable program code instructions for further processing by the AI productivity tool subagent. The ML model algorithms may also include a query input-to-intent ML model algorithm that receives the user-query input from the speech-to-text model algorithm or directly from the AI productivity tool subagent, and, with an embedding algorithm, generates a vectorized query intent value for the user-query input for later correlation with a capability intent value. Additionally, a query intent-to-capability matching ML model algorithm may receive that vectorized query intent value as input and match the vectorized query intent value to a vectorized capability intent value associated with the AI productivity tool-enablable software application via a similarity correlation algorithm, such as a vector cosine similarity search to identify a capability or plurality of capabilities that can serve as one or more capability intent actions responsive to the user-query input.

At block 308, the method 300 includes the capability intent action being identified via the execution of the ML model algorithms identifying the plurality of capabilities associated with one or more of the AI productivity tool-enablable software applications. In the context of the user-query input received from the user (e.g., “make my system run faster”) one or more of the AI productivity tool-enablable software applications may be used to execute responsive capability intent actions to adjust the clock frequency of a hardware processor, change from one hardware processor to another, engage a second hardware processor to share processing resources, stop background applications from running, cause the information handling systems to enter a “performance mode,” free up RAM space, or the like. For example, the Dell® Optimizer® software application, or any other AI productivity tool-enablable software application may include a matching capability that can fix the issues the user is having with slow processing of input from the user at the information handling systems. It is appreciated that this process may have also been carried out by other users as responsive capabilities to user query inputs at the other node information handling systems within the enterprise of information handling system such that each of the users' user-query input is being addressed via execution of the AI productivity tool software module and AI productivity tool subagent as described herein.

Proceeding to block 310, the AI productivity tool subagent may issue an instruction for the one or more identified capabilities similarity matched as responsive capability intent actions to be executed by the corresponding AI productivity tool-enablable software application executing on the information handling system. For example, the identified capabilities semantically or lexically similarity matched to the user-query input, “make my system run faster” may include the AI productivity tool subagent issuing instructions to the Dell® Optimizer® software application to increase the clock frequency of a hardware processing device. Further, in response to the user-query input, “make my system run faster,” AI productivity tool subagent may issue instructions to execute responsive capability intent actions to the Dell® Optimizer® software application to activate or otherwise select another hardware processing device to share in the processing demands associated with the execution of certain software applications (e.g., CAD drawing software applications).

At block 312, the method 300 includes executing computer-readable program code instructions of the capability intent action log generation software application by a hardware processor to gather the capability intent actions carried out by any AI productivity tool-enablable software application and resource telemetry data of performance or system status for hardware, software, or firmware of a node information handling system. The capability intent action log generation software application gather identification of the capability intent action, a use query input, and resource telemetry data of performance or system status from before and after a capability intent action execution. This gathered data is used to evaluate the capability intent action to determine an AI productivity score relating to correlation of the capability intent action to changes in the resource telemetry data of performance or system status such that improvement to processes at the node information handling systems has increased.

As described herein, evaluation of an AI productivity score for a capability intent action may be done by the capability intent action log generation software application invoking the productivity and experience scoring LLM algorithm as described herein. In an embodiment, execution of computer readable code instructions for the productivity and experience scoring LLM algorithm may receive inputs of the resource telemetry data of performance or system status metrics related to the hardware of the information handling systems, the software or firmware of the information handling systems (e.g., the OS), power states and maximum clock frequencies of selected components of the information handling systems, peripheral devices coupled to the information handling systems (either permanently or temporarily), networks available to the information handling systems and the performance characteristics of those networks, software installers available on the information handling systems, and the like. In further example embodiments, these resource telemetry data of performance or system status metrics may include clock frequencies of a hardware processor that have been increased by execution of, for example, Dell® Optimizer® software application in order to increase processing capacity of the information handling systems in order to address the user-query input (e.g., “make my system run faster”). In another example, these resource telemetry data of performance or system status metrics may include GPU temperature readings that indicate that the temperature of the GPU have increased due to, for example, a Dell® Display and Peripheral Manager® software application, executing a capability to increase the resolution of display of data at the display device. It is appreciated that other executed capabilities and resource telemetry data of performance or system status metrics may be used as input to the productivity and experience scoring LLM algorithm that may include the amount of RAM currently occupied and/or cleared by execution of the Dell® Optimizer® software application, for example. Still further, other capabilities and resource telemetry data of performance or system status metrics that may be used as input to the productivity and experience scoring LLM algorithm that may include current temperatures at the battery and hardware processing devices that may have increased as a result of increasing the processing resources at the information handling systems. Yet another capability and resource telemetry data of performance or system status metrics data that may be used as input to the productivity and experience scoring LLM algorithm may include data describing which, if any, background applications are executing or have been stopped in order to cause hardware processing resources. It is appreciated that any resource telemetry data of performance or system status metrics associated with the changes in firmware or hardware (e.g., changing display or power settings), software, or processes of one or more other AI productivity tool-enablable software applications resulting from the execution of a capability intent action may be used as input to the productivity and experience scoring LLM algorithm.

This execution, in an embodiment, of the productivity and experience scoring LLM algorithm by the capability intent action log generation software application may further generate and assign an AI productivity score related to how the executed capability intent actions have caused changes in the resource telemetry data of performance or system status metrics and improved user productivity at the plurality of information handling systems. Again, this AI productivity score is based on the current resource telemetry data of performance or system status metrics detected before and after the capability intent action and gathered by the capability intent action log generation software application. This resource telemetry data of performance or system status metrics before and after the execution of the responsive capability intent action is provided as input to the productivity and experience scoring LLM algorithm as well as the capability intent action, user query input, to determine correlation between the two as an AI productivity score associated with the increased productivity of the user at the information handling systems assuming the change is a relevant improvement to functions of the user or the node information handling system. Additionally, data input to the productivity and experience scoring LLM algorithm may include relevance data related to the user's expected functions in some embodiments for determination of a designation of a productivity improvement change in some embodiments.

In an embodiment, to calculate the productivity score, the productivity and experience scoring LLM algorithm receives, as input, two or more of a resource telemetry data metric associated with hardware of the client device, a resource telemetry data metric associated with software or firmware of the client device, a resource telemetry data metric associated with a storage system, a resource telemetry data metric associated with a user of the client device, a resource telemetry data metric associated with a network of the client device, or a resource telemetry data metric associated with a locale of the client device. A statistical correlation is drawn between the capability for the capability intent action and changes in the resource telemetry data metrics associated with the capability and even the original user query input by the productivity and experience scoring LLM algorithm and this statistical correlation, for example out of a normalized correlation value may represent the output AI productivity score. For example, an output AI productivity score may be on a scale of between 1 to 10 such that a 10 indicates that user-productivity has been increased in that the capability intent action and user query input pair more directly correlated to changes in the resource telemetry data metrics. In this example embodiment, a score of 1 indicates that the associated capability intent action and user query input pair has little to no effect on changes in the resource telemetry data metrics and, thus, little effect on the user productivity at the information handling system.

At block 314, the method 300 may further include executing computer-readable program code instructions of the capability intent action log generation software application by a hardware processor to generate a capability intent action log based on the scores and transmit that generated capability intent action log to a remote policy management server. This capability intent action log may, in an embodiment, associate each executed capability intent action with its associated capability, the associated AI productivity tool-enablable software application that executed that capability, a user query input, a capability identification, the resource telemetry data, and the assigned AI productivity score previously generated by the execution of the productivity and experience scoring LLM algorithm in some embodiments. A table may be created (e.g., Table 1 described herein) that associates the AI productivity scores with their respective capabilities/capability intent actions and capability identifications in a capability intent action log in an example embodiment. This table may be stored in a node capabilities and scoring database 392 accessible to the capability intent action log generation software application.

The capability intent action log generation software application may periodically send the generated capability intent action log to an ITDM operating an ITDM capability management system. In an embodiment, the capability intent action log generation software application may send the capability intent action log to the ITDM as new capability intent actions have been carried out and the capability intent action log has been updated with new scores associated with new capabilities and their respective capability intent actions.

At block 316, the method 300 includes a hardware processor of the remote policy management server executing computer-readable program code instructions of an ITDM capability management system to receive the capability intent action log and generate a ranked listing of the plurality of responsive capability intent actions based on the assigned AI productivity scores. This ranked listing may rank the capability intent actions received from the capability intent action logs from a plurality of node information handling systems at an enterprise capabilities and scoring database 399 by averaging accumulated assigned AI productivity scores associated with each type of responsive capability intent action and generating the ranked listing based on the average accumulated assigned AI productivity score. In an alternative embodiment, each of the AI productivity scores associated with each similar capability intent action as detailed in the plurality of received capability intent action logs from each of the reporting node information handling systems may be added together and normalized to fit within a scale of 1 to 10 with 1 being the least user-productive capability intent action and a score of 10 being the most user-productive capability intent action. In an embodiment, this ranking data may be stored on an enterprise capabilities and scoring database 399 for later retrieval.

At block 318, the method 300 further includes the ITDM capability management system generating an action payload comprising one or more of the plurality of responsive capability intent actions. These responsive capability intent actions defined in the action payload may be used to improve the user-productivity at each node information handling systems that the action payload is transmitted to. Thus, in an embodiment, the hardware processor may execute computer-readable program code instructions of the ITDM capability management system to propagate that action payload to each of the plurality of node information handling systems within the enterprise for implementation at each of those plurality of node information handling systems. For example, where the average or normalized AI productivity scores related to the capability to set system to high performance mode/overclock hardware processor may be relatively higher than averaged or normalized AI productivity scores for other capabilities that have executed at any given node information handling systems (e.g., clear RAM). As such, a highest ranked list of capability intent actions, such as a top 10 list from across an enterprise, may be represented within the action payload as a capability for one or more of the node information handling systems to execute. In other embodiments, an AI productivity score threshold may determine which capability intent actions are included in the action payload to be delivered to one or more of the node information handling systems to execute within the enterprise.

At block 320, the method 300 also includes executing, with the hardware processor of the remote policy management server, computer-readable program code instructions of the ITDM capability management system to propagate that action payload to each of the plurality of node information handling systems within the enterprise for implementation at each of those plurality of node information handling systems. Again, it is appreciated that, in some instances, the propagation of some of the action payloads may not be beneficial to all of the node information handling systems within the enterprise. For example, the overclocking of a hardware processor may have been beneficial to a user of a first information handling system who has requested to “make my system run faster” in order to address the input issues associated with the execution of a CAD drawing software application. This user may be part of an engineering product development department subgroup within the enterprise that would benefit from the execution of the capability intent action since user function expectation may include high processing requirements such as for a CAD drawing software application. However, a similar capability intent action may not be beneficial for a second or third information handling system within another department of the enterprise such as sales department node information handling systems or legal department node information handling systems. In an embodiment, the computer-readable program code instructions of the ITDM capability management system may allow the ITDM to define a grouping of node information handling systems within the enterprise such that specific and customized action payloads may be propagated to a subgroup of node information handling systems within the enterprise that would benefit from the action payload in some embodiments. The computer-readable program code instructions of the ITDM capability management system may allow the ITDM to define a grouping of node information handling systems within the enterprise such that that same action payload is not sent to another sub-group of node information handling systems within the enterprise that would not benefit from the application of the capabilities defined in the action payload in other embodiments herein.

At block 322, therefore, those capabilities defined in the action payload may be executed at those node information handling systems that have received the action payload and would benefit from the application of those capabilities at their respective node information handling systems. Because the action payload transmitted from the ITDM capability management system and remote policy management server to these node information handling systems includes those highest ranked capability intent actions, these capability intent actions are relied upon to execute improvements to increase the user productivity of those node information handling systems similar to the benefit from those capabilities intent actions executed at the reporting node information handling system or systems. This increases user productivity within the enterprise generally. Thus, the system and method 300 described herein creates pro-active action payloads to remediate, secure, and manage the information handling systems within an enterprise thereby allowing for crowd generated user productivity solutions. At this point, the method 300 may end.

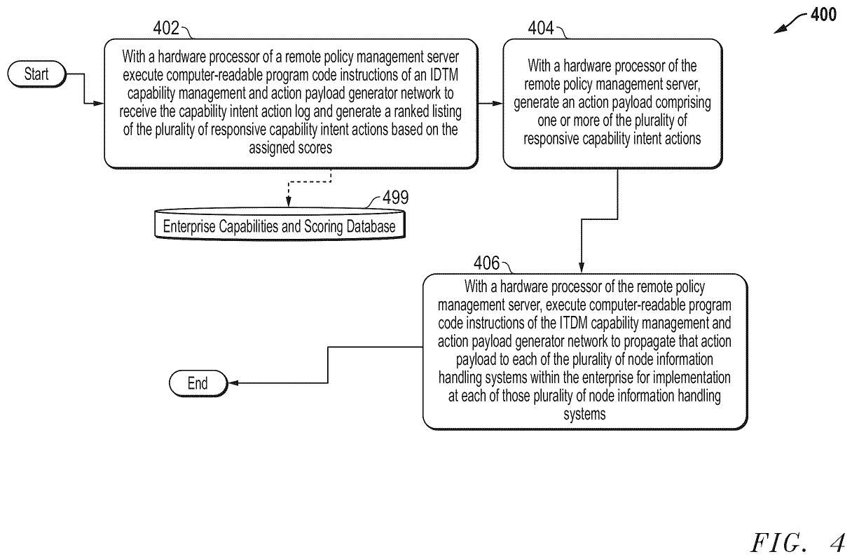

FIG. 4 is a flow diagram showing a method 400 of executing computer readable code instructions of an ITDM capabilities management system for creating proactive action payloads for implementation at a plurality of information handling systems within an enterprise according to an embodiment of the present disclosure according to another embodiment of the present disclosure. The method 400 described in connection with FIG. 4 may be operated on a remote policy management server executing computer-readable program code instructions of the ITDM capability management system such as those described in connection with FIG. 1 or 2.

At block 402, the method 400 includes a hardware processor of a remote policy management server executing computer-readable program code instructions of an ITDM capability management system to receive the capability intent action log or logs from at least one node information handling system and generate a ranked listing of the plurality of responsive capability intent actions based on the assigned AI productivity scores therein. This ranked listing may rank the capability intent actions received from the capability intent action logs from a plurality of node information handling systems by averaging an accumulated assigned AI productivity scores associated with each type of responsive capability intent action and generating the ranked listing based on the average accumulated assigned AI productivity score. In an alternative embodiment, each of the scores associated with each similar capability intent action as detailed in the plurality of received capability intent action logs from each node information handling systems may be added together and normalized to fit within a scale of 1 to 10 with 1 being the least user-productive capability intent action and a score of 10 being the most user-productive capability intent action. In an embodiment, the data of the capability intent action logs and tanked lists may be stored on an enterprise capabilities and scoring database 499 for later retrieval.

At block 404, the method 400 further includes the ITDM capability management system generating an action payload comprising one or more of the plurality of responsive capability intent actions. These responsive capability intent actions defined in the action payload may be highly ranked or capability intent action with an AI productivity score above a threshold that may be used to improve the user-productivity across plural node information handling systems that the action payloads are transmitted to. Thus, in an embodiment, the hardware processor may execute computer-readable program code instructions of the ITDM capability management system to propagate that action payload to each of the plurality of node information handling systems within the enterprise for implementation at each of those plurality of node information handling systems. In embodiments, the action payloads in some embodiments may be generated for particular sub-group categories designated by an ITDM, such as an engineering department subgroup in embodiments herein. For example, where the AI productivity score related to the capability intent action for setting the system to high performance mode/overclock hardware processor capability (e.g., capability ID 0004) is relatively higher than other capabilities that have increased user productivity at any given node information handling systems (e.g., clear RAM; capability ID 0002) this capability may be represented within the action payload as a capability for one or more of the node information handling systems to execute. However, an action payload for the capability intent action for setting the system to high performance mode/overclock hardware processor capability may be designated for an engineering department node information handling system due to persona data indicating high processing requirements, but not designated for sales department node information handling systems in some embodiments herein.

At block 406, the method 400 also includes executing, with the hardware processor of the remote policy management server, computer-readable program code instructions of the ITDM capability management system to propagate that action payload to each of the plurality of node information handling systems within the enterprise for implementation at each of those plurality of node information handling systems. Again, it is appreciated that, in some instances, the propagation of some of the action payloads may not be beneficial to all of the node information handling systems within the enterprise. For example, the overclocking of a hardware processor may have been beneficial to a user of a first information handling system who has requested to “make my system run faster” in order to address the input issues associated with the execution of a CAD drawing software application. This user may be part of an engineering product development department within the enterprise and would benefit from the execution of the capability intent action. However, a similar capability intent action may not be beneficial for a second or third information handling system within another department of the enterprise such as a lawyer's information handling systems or a secretary's information handling systems. In an embodiment, the computer-readable program code instructions (e.g., software algorithms) parameters, and profiles of the ITDM capability management system may allow the ITDM to define a grouping of node information handling systems within the enterprise such that specific and customized action payloads may be propagated to a subgroup of node information handling systems within the enterprise that would benefit from the action payload while the same action payload is not sent to another sub-group of node information handling systems within the enterprise that would not benefit from the application of the capabilities defined in the action payload.

Further, execution of the computer-readable program code instructions of the ITDM capability management system to propagate that action payload to each of the plurality of node information handling systems within the enterprise may transmit those action payloads via a certification process in embodiments herein to maintain security of the action payload transfer. For example, an action payload certification process may include use of a symmetric encryption key with a public key on the node information handling system and a private key at the remote policy management server in some embodiments.

This method 400 provides for those capabilities defined in the action payload to be executed at those information handling systems that have received the action payload and would benefit from the application of those capabilities at their respective information handling systems. Because the action payload transmitted from the ITDM capability management system and remote policy management server to these node information handling systems includes those highest ranked capability intent actions that increases the user productivity of the information handling systems, other node information handling systems may benefit from those capabilities intent actions executed at a single information handling system. Then, beneficial capability intent actions may be automatically distributed to enterprise node information handling systems that may not be otherwise utilizing the AI productivity tool to maximize operations of its node information handling system. Execution of those action payloads for highly ranked capability intent actions may be executed across relevant node information handling systems that is relatively assured to improve operation and, thus, increase productivity of those users. This increases user productivity within the enterprise generally. Thus, the system and method 400 described herein creates pro-active action payloads to remediate, secure, and manage the node information handling systems within an enterprise thereby allowing for crowd generated user productivity solutions. At this point, the method may end.

The systems and methods 400 described herein, therefore, allows for augmented capability intent action policies to be propagated across one or more information handling system information handling systems based on how each user uses the AI productivity tool software application. Indeed, because each user may use different syntax or language with their individual user-query input to get certain capability intent actions carried out, the system and methods described herein can address all of these different user-query inputs in s similar way thereby using the sentiments of the group of users to help in the capability intent actions carried out by one or more information handling system information handling systems. It is appreciated that the systems and methods described herein may be used across all types of information handling system information handling systems operating any type of AI productivity tool software application described herein. The ITDM may more easily generate augmented capability intent action policies for a plurality of information handling system information handling systems within an enterprise so that the ITDM does not need to address the issues with every single information handling system information handling system repeatedly.

The blocks of the flow diagrams of FIG. 3 or 4 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. A server information handling system comprising:
a hardware processor, a memory device, and a power management unit to provide power to the hardware processor and memory device;
the hardware processor to execute computer-readable program code instructions of an internet technology decision maker (ITDM) capability management system to receive capability intent action logs from a first subset of a plurality of node information handling systems of an enterprise including a plurality of responsive capability intent actions executed responsive to user-query inputs and assigned AI productivity scores for each responsive capability intent action generated from correlation of resource telemetry data for performance or status of hardware, firmware, or software at each of the plurality of node information handling systems before and after execution of the responsive capability intent action, where the assigned AI productivity score is related to user productivity;
the hardware processor to execute computer-readable program code instructions of the ITDM capability management system to generate a ranked listing of the plurality of responsive capability intent actions based on the assigned AI productivity scores received from the first subset of the plurality of node information handling systems;
the hardware processor to execute computer-readable program code instructions of the ITDM capability management system to generate an action payload comprising one or more high AI productivity score responsive capability intent actions having a highest set of AI productivity scores among the plurality of responsive capability intent actions received; and
the hardware processor to execute computer-readable program code instructions of the ITDM capability management system to propagate that action payload via a network interface device to the plurality of node information handling systems within the enterprise for implementation at the plurality of node information handling systems.

2. The server information handling system of claim 1 further comprising:
the hardware processor to execute the computer-readable program code instructions of the ITDM capability management system to store the capability intent action logs from the first subset of a plurality of node information handling systems and the ranked listing of the plurality of responsive capability intent actions at an enterprise capabilities and scoring database for reference when generating the action payload of high AI productivity score responsive capability intent actions from the ranked listing.

3. The server information handling system of claim 1 further comprising:
the hardware processor to execute the computer-readable program code instructions of the ITDM capability management system to receive an identification associated with a first received responsive capability intent action and compare that identification to an identification of other responsive capability intent actions stored on an enterprise capabilities and scoring database to determine common types of capability intent actions received from the first subset of the plurality of node information handling systems.

4. The server information handling system of claim 1 further comprising:
the hardware processor to execute the computer-readable program code instructions of the ITDM capability management system to generate the ranked listing of the plurality of responsive capability intent actions by averaging accumulated assigned AI productivity scores associated with each type of the responsive capability intent actions and generating the ranked listing based on the average accumulated assigned AI productivity scores.

5. The server information handling system of claim 1 further comprising:
the hardware processor to execute the computer-readable program code instructions of the ITDM capability management system to disregard responsive capability intent actions from the action payload that are associated with designated results in resource telemetry data for performance or status of hardware, firmware, or software that does not improve user productivity at the plurality of node information handling systems.

6. The server information handling system of claim 1 further comprising:
an enterprise capabilities and scoring database operatively coupled to the ITDM capability management system for the ITDM capability management system, the enterprise capabilities and scoring database comprising a listing of responsive capability intent actions with changes in resource telemetry data for performance or status of hardware, firmware, or software that are designated as not resulting in improved user productivity at the plurality of node information handling systems for reference by the ITDM capability management system to disregard when generating the action payload.

7. The server information handling system of claim 1 further comprising:
the hardware processor executing the computer-readable program code instructions of the ITDM capability management system to encrypt the action payload with a public key prior to propagation of the action payload to each of the plurality of node information handling systems within the enterprise.

8. The server information handling system of claim 1 further comprising:
the hardware processor executing the computer-readable program code instructions of the ITDM capability management system to group the plurality of node information handling systems within the enterprise into categories of node information handling systems that includes non-benefitting node information handling systems that would not benefit from the receipt of the action payload and benefitting node information handling systems that would benefit from the receipt of the action payload based on user expected functions associated with the user of the node information handling systems; and
the network interface device to transmit the action payload to a second subgroup of the plurality of node information handling systems that are benefitting node information handling systems.

9. A method of executing computer readable code instructions for creating proactive action payloads for implementation at a plurality of node information handling systems within an enterprise comprising:
executing, with a hardware processor, computer-readable program code instructions of an ITDM capability management system to receive capability intent action logs from a first subset of a plurality of node information handling systems of an enterprise including a plurality of responsive capability intent actions executed responsive to user-query input, the user query inputs, and assigned AI productivity scores for each responsive capability intent action generated from correlation of resource telemetry data for performance or status of hardware, firmware, or software at each of the plurality of node information handling systems before and after execution of the responsive capability intent action, where the assigned AI productivity scores are related to how the executed capability intent actions have improved user productivity;
executing computer-readable program code instructions of the ITDM capability management system to generate a ranked listing of the plurality of responsive capability intent actions based on averaged accumulated assigned AI productivity scores averaged from plural assigned AI productivity scores for each capability intent action type received from the first subset of the plurality of node information handling systems;
executing computer-readable program code instructions of the ITDM capability management system to generate an action payload comprising one or more high AI productivity score responsive capability intent actions having a highest set of averaged accumulated assigned AI productivity scores among the plurality of responsive capability intent actions received; and
executing computer-readable program code instructions of the ITDM capability management system to transmit that action payload via a network interface device to the plurality of node information handling systems within the enterprise for implementation of the one or more high AI productivity score responsive capability intent actions at each of the plurality of node information handling systems.

10. The method of claim 9 further comprising:
executing, with the hardware processor, computer-readable program code instructions of the ITDM capability management system to access an enterprise capabilities and scoring database to store the responsive capability intent actions and assigned AI productivity scores of the responsive capability intent actions from the first subset of the plurality of node information handling systems for reference when generating the ranked listing of the plurality of responsive capability intent actions based on the averaged accumulated assigned AI productivity scores.

11. The method of claim 9 wherein the highest set of averaged accumulated assigned AI productivity scores includes selecting the top ten or fewer averaged accumulated assigned AI productivity scores for responsive capability intent actions from among the plurality of responsive capability intent actions received from the first subset of the plurality of node information handling systems.

12. The method of claim 9 wherein the highest set of averaged accumulated assigned AI productivity scores includes selecting the averaged accumulated assigned AI productivity scores for responsive capability intent actions that exceed a threshold AI productivity score from among the plurality of responsive capability intent actions received from the first subset of the plurality of node information handling systems.

13. The method of claim 9 further comprising:
executing, with the hardware processor, computer-readable program code instructions of the ITDM capability management system to disregard responsive capability intent actions that are designated as not resulting in improved user productivity at the plurality of node information handling systems from inclusion in the action payload.

14. The method of claim 9 further comprising:
executing the computer-readable program code instructions of the ITDM capability management system to group the plurality of node information handling systems within the enterprise into categories of node information handling systems that includes non-benefitting node information handling systems that would not benefit from the receipt of the action payload and benefitting node information handling systems that would benefit from the receipt of the action payload based on user expected functions associated with the user of the node information handling systems; and
transmitting, via the network interface device, the action payload to a second subgroup of the plurality of node information handling systems that are benefitting node information handling systems.

15. The method of claim 9, further comprising:
executing, with the hardware processor, computer-readable program code instructions of the ITDM capability management system to encrypt the action payload with a public key prior to propagation of the action payload to each of the plurality of node information handling systems within the enterprise.

16. A server information handling system for creating proactive action payloads for implementation at a plurality of node information handling systems within an enterprise comprising:
a hardware processor, a memory device, and a power management unit to provide power to the hardware processor and memory device;
the hardware processor to execute computer-readable program code instructions of an internet technology decision maker (ITDM) capability management system to receive capability intent action logs from a first subset of a plurality of node information handling systems of an enterprise including a plurality of responsive capability intent actions executed responsive to user-query input and assigned AI productivity scores for each responsive capability intent action generated from correlation of resource telemetry data for hardware, firmware, or software at each of the plurality of node information handling systems before and after execution of the responsive capability intent action, where the assigned AI productivity scores are related to user productivity at the first subset of the plurality of node information handling systems;
the hardware processor to execute computer-readable program code instructions of the ITDM capability management system to generate a ranked listing of the plurality of responsive capability intent actions based on the assigned AI productivity scores received from the first subset of the plurality of node information handling systems;
the hardware processor to execute computer-readable program code instructions of the ITDM capability management system to reference a listing of responsive capability intent actions designated as not resulting in improved user productivity at the plurality of node information handling systems in an enterprise capabilities and scoring database;
the hardware processor to execute computer-readable program code instructions of the ITDM capability management system to disregard the responsive capability intent actions that cannot result in improved user productivity and to generate the action payload comprising one or more high AI productivity score responsive capability intent actions having a highest set of AI productivity scores among the remaining plurality of responsive capability intent actions; and
the hardware processor to execute computer-readable program code instructions of the ITDM capability management system to propagate that action payload via a network interface device to the plurality of node information handling systems within the enterprise for implementation at each of the plurality of node information handling systems.

17. The server information handling system of claim 16 further comprising:
the enterprise capabilities and scoring database to store the responsive capability intent actions and assigned AI productivity scores of the capability intent action logs received from the first subset of a plurality of node information handling systems for reference when generating the ranked listing of the plurality of responsive capability intent actions based on the assigned AI productivity scores.

18. The server information handling system of claim 16 further comprising:
the hardware processor executing the computer-readable program code instructions of the ITDM capability management system to group the plurality of node information handling systems within the enterprise into categories of node information handling systems that includes non-benefitting node information handling systems that would not benefit from the receipt of the action payload and benefitting node information handling systems that would benefit from the receipt of the action payload based on user expected functions associated with the user of the node information handling systems; and
the network interface device to transmit the action payload to a second subgroup of the plurality of node information handling systems that are benefitting node information handling systems.

19. The server information handling system of claim 16 further comprising:
the hardware processor to execute the computer-readable program code instructions of the ITDM capability management system to generate the ranked listing of the plurality of responsive capability intent actions by averaging an accumulated assigned AI productivity score associated with each type of responsive capability intent action received and generating the ranked listing based on the average accumulated assigned AI productivity score.

20. The server information handling system of claim 16 further comprising:
the hardware processor executing the computer-readable program code instructions of the ITDM capability management system to encrypt the action payload with a public key prior to propagation of the action payload to each of the plurality of node information handling systems within the enterprise.
